(19) United States
(12) Patent Application Publication
(10) Pub. No.: US 2024/0310312 A1
(43) Pub. Date: Sep. 19, 2024

(54) PREDICTION RESULT VISUALIZING APPARATUS AND PREDICTION RESULT VISUALIZING METHOD

(71) Applicant: Proterial, Ltd., Tokyo (JP)

(72) Inventors: Tomonori WATANABE, Tokyo (JP); Daisuke SHANAI, Tokyo (JP)

(21) Appl. No.: 18/600,911

(22) Filed: Mar. 11, 2024

(30) Foreign Application Priority Data
Mar. 13, 2023 (JP) 2023-038890

(51) Int. Cl. G01N 27/00

(52) U.S. Cl. CPC G01N 27/00

(57) ABSTRACT

Tendency of change in physical quantities is easily recognized. For example, under a precondition that predictive values of a plurality of physical quantities are acquired by use of regression models, a plurality of predictive values of single physical quantity are acquired while changing blend rate for the plurality of physical quantities, and then, a blend rate of a composite material having the plurality of physical quantities all satisfying the predetermined conditions is visualized, on basis of prediction results of the plurality of physical quantities corresponded to the changed blend rate.

### CROSS-REFERENCE TO RELATED APPLICATION

This application claims foreign priority benefits under 35 U.S.C. § 119 from Japanese Patent Application No. 2023-038890, filed Mar. 13, 2023, the content of which are hereby incorporated by reference in their entirety.

### TECHNICAL FIELD OF THE INVENTION

The present invention relates to a prediction result visualizing apparatus and a prediction result visualizing method, and relates to a technique effectively applied to, for example, a technique of visualizing prediction results of physical quantities depending on a blend rate of a composite material.

### BACKGROUND OF THE INVENTION

Japanese Patent Application Laid-open Publication No. 2020-535566 (Patent Document 1) describes a technique of drawing a graph for predictive values of material properties.

### SUMMARY OF THE INVENTION

For example, a value of a physical quantity (physical property value) of a composite material may change depending on a blend rate of a constituent material making the composite material. Thus, in order to select the blend rate having the physical quantities of the composite material all satisfying the predetermined conditions, it is necessary to recognize tendency of change in the physical quantities when the blend rate is changed. Particularly when the blend rate at which the physical quantities relatively have a margin for the standard values are desirably selected, it is important to recognize the tendency of change in the physical quantities.

In this regard, it is difficult to recognize the tendency of change in the physical quantities on the basis of the resultant experimental data from actual experiments. This is because the number of items of experimental data is limited in many cases, and it is difficult to recognize accurate tendency of change in the physical quantities from the limited number of items of experimental data. To the contrary, preparation for a sufficient number of items of experimental data increases personnel and time costs.

Thus, an attempt has been considered, the attempt being to create regression models by using machine leaning based on the experimental data to acquire the predictive values of the physical quantities by use of the regression models even if the number of items of experimental data is not sufficient. That is, an attempt has been considered, the attempt being to compensate the insufficient number of items of experimental data by acquiring the predictive values to recognize the tendency of change in the physical quantities on the basis of the predictive values of the sufficient number of items of data. In this manner, the tendency of change in the physical quantities can be recognized even without the sufficient number of items of experimental data.

In this case, even when the tendency of change in the physical quantities are acquired based on the predictive values, if the tendency of change in the physical quantities cannot be easily recognized, the tendency of change in the physical quantities based on the predictive values cannot be sufficiently utilized. That is, while the data on the tendency of change in the physical quantities can be acquired by the acquirement of the predictive values of the physical quantities by use of the regression models, it is important to easily visualize the tendency of change in the physical quantities. This is because if the tendency of change in the physical quantities can be recognized at a glance, the blend rate satisfying the predetermined conditions can be easily selected based on the visualized tendency of change in the physical quantities. That is, under a precondition that the predictive values of the physical quantities are acquired by use of the regression models, it is desired to visualize the prediction results in order to easily recognize the tendency of change in the physical quantities. That is, an objective of one embodiment is to easily recognize the tendency of change in the physical quantities.

A prediction result visualizing apparatus according to one embodiment is a prediction result visualizing apparatus visualizing a prediction result of a physical quantity of a composite material containing two or more materials belonging to a plurality of different materials as constituent materials. In this case, the apparatus includes: a first predictive value calculation section configured to calculate a first predictive value of a first physical quantity of an unknown composite material on basis of a first regression model and blend information including a material name and a blend rate of a constituent material contained in the unknown composite material having an unknown value of the first physical quantity and an unknown value of a second physical quantity; a second predictive value calculation section configured to calculate a second predictive value of the second physical quantity of the unknown composite material on basis of a second regression model and the blend information including the material name and the blend rate of the constituent material contained in the unknown composite material; a prediction result acquisition section configured to acquire a prediction result which is based on a plurality of first predictive values calculated by the first predictive value calculation section while changing the blend rate and a plurality of second predictive values calculated by the second predictive value calculation section while changing the blend rate and which is corresponded to the changed blend rate; and a visualization section configured to visualize the prediction result. In this case, the first regression model is a function to output the first predictive value of the first physical quantity in response to input of the blend information, and the second regression model is a function to output the second predictive value of the second physical quantity in response to input of the blend information.

A program according to one embodiment is a program causing a computer to execute a processing of visualizing a prediction result of a physical quantity of a composite material containing two or more materials belonging to a plurality of different materials as constituent materials. In this case, the program includes: a first predictive value calculation processing of calculating a first predictive value of a first physical quantity of an unknown composite material on basis of a first regression model and blend information including a material name and a blend rate of a constituent material contained in the unknown composite material having an unknown value of the first physical quantity and an unknown value of a second physical quantity; a second predictive value calculation processing of calculating a second predictive value of the second physical quantity of the unknown composite material on basis of a second regression model and the blend information including the material name and the blend rate of the constituent material contained in the unknown composite material; a prediction result acquisition processing of acquiring a prediction result which is based on a plurality of first predictive values calculated by the first predictive value calculation processing while changing the blend rate and a plurality of second predictive values calculated by the second predictive value calculation processing while changing the blend rate and which is corresponded to the changed blend rate; and a visualization processing of visualizing the prediction result. In this case, the first regression model is a function to output the first predictive value of the first physical quantity in response to input of the blend information, and the second regression model is a function to output the second predictive value of the second physical quantity in response to input of the blend information.

A recording medium according to one embodiment is a computer-readable recording medium recording the program therein.

A prediction result visualizing method according to one embodiment is a prediction result visualizing method of causing a computer to visualize a prediction result of a physical quantity of a composite material containing two or more materials belonging to a plurality of different materials as constituent materials. In this case, the method includes: a first predictive value calculation step of causing the computer to calculate a first predictive value of a first physical quantity of an unknown composite material on basis of a first regression model and blend information including a material name and a blend rate of a constituent material contained in the unknown composite material having an unknown value of the first physical quantity and an unknown value of a second physical quantity; a second predictive value calculation step of causing the computer to calculate a second predictive value of the second physical quantity of the unknown composite material on basis of a second regression model and the blend information including the material name and the blend rate of the constituent material contained in the unknown composite material; a prediction result acquisition step of causing the computer to acquire a prediction result which is based on a plurality of first predictive values calculated by the first predictive value calculation step while changing the blend rate and a plurality of second predictive values calculated by the second predictive value calculation step while changing the blend rate and which is corresponded to the changed blend rate; and a visualization step of causing the computer to visualize the prediction result. In this case, the first regression model is a function to output the first predictive value of the first physical quantity in response to input of the blend information, and the second regression model is a function to output the second predictive value of the second physical quantity in response to input of the blend information.

A prediction result visualizing apparatus according to one embodiment is a prediction result visualizing apparatus visualizing a prediction result of a physical quantity of a composite material containing two or more materials belonging to a plurality of different materials as constituent materials. In this case, the apparatus includes: a first predictive value input section configured to input a first predictive value of a first physical quantity of an unknown composite material calculated on basis of a first regression model and blend information including a material name and a blend rate of a constituent material contained in the unknown composite material having an unknown value of the first physical quantity and an unknown value of a second physical quantity; a second predictive value input section configured to input a second predictive value of the second physical quantity of the unknown composite material calculated on basis of a second regression model and the blend information including the material name and the blend rate of the constituent material contained in the unknown composite material; a prediction result acquisition section configured to acquire a prediction result which is based on a plurality of first predictive values calculated while changing the blend rate and input by the first predictive value input section and a plurality of second predictive values calculated while changing the blend rate and input by the second predictive value input section and which is corresponded to the changed blend rate; and a visualization section configured to visualize the prediction result. In this case, the first regression model is a function to output the first predictive value of the first physical quantity in response to input of the blend information, and the second regression model is a function to output the second predictive value of the second physical quantity in response to input of the blend information.

A program according to one embodiment is a program causing a computer to execute a processing of visualizing a prediction result of a physical quantity of a composite material containing two or more materials belonging to a plurality of different materials as constituent materials. In this case, the program includes: a first predictive value input processing of inputting a first predictive value of a first physical quantity of an unknown composite material calculated on basis of a first regression model and blend information including a material name and a blend rate of a constituent material contained in the unknown composite material having an unknown value of the first physical quantity and an unknown value of a second physical quantity; a second predictive value input processing of inputting a second predictive value of the second physical quantity of the unknown composite material calculated on basis of a second regression model and the blend information including the material name and the blend rate of the constituent material contained in the unknown composite material; a prediction result acquisition processing of acquiring a prediction result which is based on a plurality of first predictive values calculated while changing the blend rate and input by the first predictive value input processing and a plurality of second predictive values calculated while changing the blend rate and input by the second predictive value input processing and which is corresponded to the changed blend rate; and a visualization processing of visualizing the prediction result. In this case, the first regression model is a function to output the first predictive value of the first physical quantity in response to input of the blend information, and the second regression model is a function to output the second predictive value of the second physical quantity in response to input of the blend information.

A recording medium according to one embodiment is a computer-readable recording medium recording the program therein.

A prediction result visualizing method according to one embodiment is a prediction result visualizing method of causing a computer to visualize a prediction result of a physical quantity of a composite material containing two or more materials belonging to a plurality of different materials as constituent materials. In this case, the method includes: a first predictive value input step of causing the computer to input a first predictive value of a first physical quantity of an unknown composite material calculated on basis of a first regression model and blend information including a material name and a blend rate of a constituent material contained in the unknown composite material having an unknown value of the first physical quantity and an unknown value of a second physical quantity; a second predictive value input step of causing the computer to input a second predictive value of the second physical quantity of the unknown composite material calculated on basis of a second regression model and the blend information including the material name and the blend rate of the constituent material contained in the unknown composite material; a prediction result acquisition step of causing the computer to acquire a prediction result which is based on a plurality of first predictive values calculated while changing the blend rate and input by the first predictive value input step and a plurality of second predictive values calculated while changing the blend rate and input by the second predictive value input step and which is corresponded to the changed blend rate; and a visualization step of causing the computer to visualize the prediction result. In this case, the first regression model is a function to output the first predictive value of the first physical quantity in response to input of the blend information, and the second regression model is a function to output the second predictive value of the second physical quantity in response to input of the blend information.

According to one embodiment, tendency of change in physical quantities can be easily recognized.

### BRIEF DESCRIPTIONS OF THE DRAWINGS

FIG. 1 is a diagram showing an exemplary hardware configuration of a prediction result visualizing apparatus.

FIG. 2 is a functional block diagram of the prediction result visualizing apparatus.

FIG. 3 is a flowchart for explaining a first regression model generating operation.

FIG. 4 is a flowchart for explaining a second regression model generating operation.

FIG. 5 is a flowchart for explaining a pass/fail determination result visualizing operation.

FIG. 6 is a functional block diagram showing an example in which a prediction result visualizing system is configured of a prediction result visualizing apparatus and a regression model generating apparatus.

FIG. 7 is a table indicating a composition and a blend rate of a composite material used in a specific example.

FIG. 8 is a table indicating an exemplary first predictive value table.

FIG. 9 is a table indicating an exemplary second predictive value table.

FIG. 10 is a table indicating an exemplary pass/fail determination result.

FIG. 11 is a table indicating an exemplary visualized pass/fail determination result.

FIG. 12 is a functional block diagram of a prediction result visualizing apparatus.

FIG. 13 is a table indicating an exemplary first predictive value table.

FIG. 14 is a table indicating an exemplary first standard deviation table.

FIG. 15 is a diagram schematically showing a method of calculating a first pass probability.

FIG. 16 is a table indicating an exemplary first pass probability table.

FIG. 17 is a table indicating an exemplary probability result (probability result table).

FIG. 18 is a table indicating an exemplary visualized probability result.

FIG. 19 is a table indicating another exemplary visualized probability result.

FIG. 20 is a flowchart for explaining an operation of the prediction result visualizing apparatus.

### DESCRIPTIONS OF THE PREFERRED EMBODIMENT

The same components are denoted by the same reference signs throughout all the drawings for describing the embodiments, and the repetitive description thereof will be omitted. Note that hatching may be used even in a plan view so as to make the drawings easy to see.

A technical idea of the present embodiment is an idea related to a technique of visualizing a predictive value of a physical quantity corresponding to a blend rate of a composite material that is complex of a plurality of types of resin or blending agents.

As the composite material described here, for example, a wire coating material containing resin or a blending agent is exemplified. As the physical quantity, for example, elongation and tensile strength of the composite material are exemplified.

The resin is, for example, polyolefin such as high-density polyethylene, low-density polyethylene, and ethylene-acrylic acid copolymer, or elastomer such as chlorinated polyethylene. Meanwhile, as the blending agent, for example, a filler such as talc, calcium carbonate, or silica, a plasticizer, a cross-linker, and a stabilizer are exemplified. However, the type and the number of the constituent materials such as the resin or the blending agent making the composite material are not limited.

Note that the technical idea of the present embodiment is applicable to not only the composite material that is the complex of the plurality of types of resin or blending agents but also a composite material that is a complex of a plurality of types of magnetic materials. As the physical quantity, for example, magnetic susceptibility or magnitude of a magnetic field (magnetic flux density).

### <Study on Improvement>

For example, in order to select the blend rate having the physical quantities of the composite material satisfying the predetermined conditions, it is desirable to recognize the tendency of change in the physical quantities in case of change in the blend rate. However, it is not sufficient to recognize only a tendency of change in a single physical quantity. This is because while there are a plurality of physical quantities for the composite material, the physical quantities need to satisfy the predetermined conditions. Specifically, in an example of the wire coating material containing resin or blending agents as the composite material, initial tensile strength (TS), initial elongation (TE), aging retention, oilproof retention (tensile strength), oilproof retention (elongation), anti-fuel retention (tensile strength), anti-fuel retention (elongation), and low-temperature elongation are exemplified as the plurality of physical quantities. All the physical quantities need to satisfy the predetermined conditions in order to manufacture the wire coating material as an excellent-quality product.

Thus, it cannot be said that it is sufficient to recognize only the tendency of change in the single physical quantity in order to select the blend rate having the physical quantities of the composite material satisfying the predetermined conditions, and it is desired to recognize tendency of change in the plurality of physical quantities. In order to achieve the easy selection of the blend rate having the physical quantities satisfying the predetermined conditions, it is desired to recognize the tendency of change in the physical quantities, and besides, to visualize the blend rate having the physical quantities all satisfying the predetermined conditions at a glance.

Therefore, even if the technique of visualizing the tendency of change in the single physical quantity already exists, the technique is not sufficient for selecting the blend rate of the composite material having the physical quantities all satisfying the predetermined conditions, and has room for improvement.

Accordingly, in the present embodiment, a devisal for solving the room for the improvement has been made. A technical idea of the present embodiment with this devisal will be described below.

### Basic Idea of Embodiment

A basic idea of the present embodiment is in a precondition that the predictive values of the plurality of physical quantities are acquired by use of regression models, the plurality of predictive values are acquired for each of a plurality of physical quantities while changing the blend rate, and then, the blend rate of the composite material having the physical quantities all satisfying the predetermined conditions is visualized on basis of the prediction results of the physical quantities corresponded to the changed blend rate.

According to the basic idea, the blend rate having the physical quantities all satisfying the predetermined conditions can be recognized at a glance, and therefore, this basic idea provides a remarkable effect capable of easily selecting the blend rate of the composite material satisfying the predetermined conditions. Consequently, according to the basic idea, the tendency of change in the physical quantities can be easily recognized, and, as a result, the desired blend rate can be easily determined.

For example, “heatmap display” is exemplified as means for visualizing the blend rate of the composite material having the physical quantities all satisfying the predetermined conditions. The “heatmap display” requires a sufficient amount of data. However, in the basic idea, a large number of predictive values can be acquired by use of regression models instead of experimental data which is originally difficult to be collected, and therefore, the “heatmap display” can be achieved.

The “heatmap display” can be achieved in a form of, for example, a two-dimensional table with a first axis and a second axis. Specifically, a blend rate of a first constituent material making the composite material is allocated to the first axis while a blend rate of a second constituent material making the composite material is allocated to the second axis, and each of a plurality of cells specified by a value allocated to the first axis and a value allocated to the second axis is displayed to indicate whether all the physical quantities (predictive values) satisfy the predetermined conditions.

For example, as an example of the display, displays based on color change, color density and others are exemplified. By the use of such “heatmap display”, it can be recognized at a glance whether all the physical quantities (predictive values) satisfy the predetermined conditions. Consequently, the desired blend rate can be easily determined with reference to the “heatmap display.” Note that the “heatmap display” is not limited to biaxial display, and, for example, uniaxial display or triaxial display is applicable.

### <First Specific Aspect>

A first specific aspect specifying the basic idea will be described below.

Typical terms described in the first specific aspect will be first defined.

The term “property value” described in the present specification means, for example, a thermal property, a mechanical property, a physical property, or the like. For example, the thermal property includes melting heat, melt flow rate, or the like. The physical property includes specific gravity. On the other hand, meaning of a term “physical quantity” is assumed as elongation, tensile strength, or the like.

In the present specification, the term “property value” and a term “physical-quantity predictive value” are definitely discriminated from each other to be used. Specifically, the “property value” is a parameter used to generate the regression model and to input the regression model. The “physical-quantity predictive value” is a value that is output from the regression model, and that is calculated by the prediction result visualizing apparatus according to the present embodiment.

The following explanation will be made while taking an example in which the prediction result visualizing apparatus specifying the basic idea is configured of a single computer.

However, the prediction result visualizing apparatus according to the present embodiment may be achieved by a distributed system configured of a plurality of computers. Note that the prediction result visualizing apparatus is an apparatus to visualize the prediction result of the physical quantity of the composite material containing two or more constituent materials belonging to the plurality of different materials.

### <<Configuration of Prediction Result Visualizing Apparatus>>

### <<<Hardware Configuration>>>

A hardware configuration of the prediction result visualizing apparatus according to the present embodiment will be described.

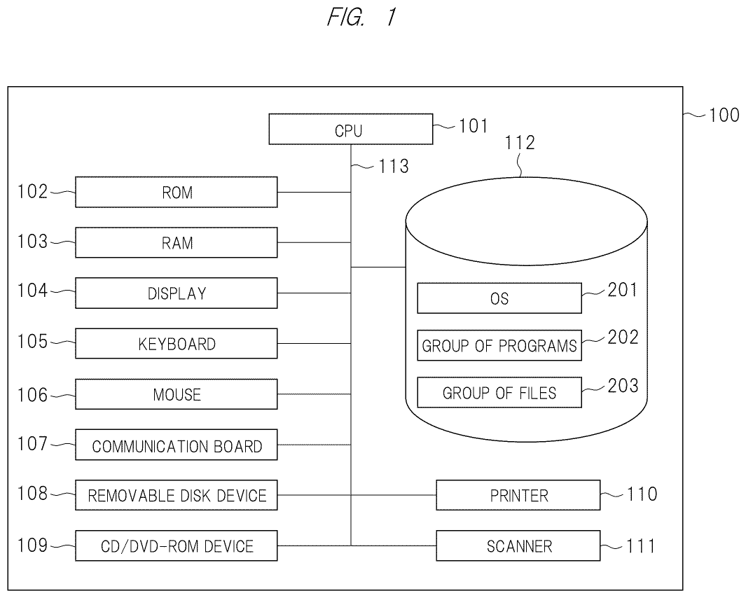

FIG. 1 is a diagram showing an exemplary hardware configuration of a prediction result visualizing apparatus 100 according to the first specific aspect. Note that the configuration of FIG. 1 merely represents an exemplary hardware configuration of the prediction result visualizing apparatus 100, and the hardware configuration of the prediction result visualizing apparatus 100 is not limited to the configuration of FIG. 1, and may be other configuration.

In FIG. 1, the prediction result visualizing apparatus 100 includes a central processing unit (CPU) 101 executing a program. The CPU 101 is electrically connected to, for example, a read only memory (ROM) 102, a random access memory (RAM) 103, and a hard disk device 112 via a bus 113, and is configured to control the hardware device.

The CPU 101 is also connected to an input device and an output device via the bus 113. As the input device, a keyboard 105, a mouse 106, a communication board 107, a scanner 111, and the like are exemplified. On the other hand, as the output device, a display 104, the communication board 107, a printer 110, and the like are exemplified. The CPU 101 may be further connected to, for example, a removable disk device 108 or a CD/DVD-ROM device 109.

The prediction result visualizing apparatus 100 may be connected to, for example, a network. For example, when the prediction result visualizing apparatus 100 is connected to other external device via the network, the communication board 107 configuring part of the prediction result visualizing apparatus 100 is connected to a local area network (LAN), a wide area network (WAN), or the Internet.

The RAM 103 is an exemplary volatile memory, and the recording mediums such as the ROM 102, the removable disk device 108, the CD/DVD-ROM device 109, and the hard disk device 112 are exemplary nonvolatile memories. A storage device of the prediction result visualizing apparatus 100 is configured of such a volatile memory or nonvolatile memory.

The hard disk device 112 stores, for example, an operating system (OS) 201, a group of programs 202, and a group of files 203 therein. The CPU 101 executes the programs included in the group of programs 202 while utilizing the operating system 201. The RAM 103 temporarily stores at least some of the programs of the operating system 201 or application programs executed by the CPU 101 therein, and stores various items of data required for the processings of the CPU 101 therein.

The ROM 102 stores a basic input output system (BIOS) program therein, and the hard disk device 112 stores a boot program therein. At the time of starting up of the prediction result visualizing apparatus 100, the BIOS program stored in the ROM 102 and the boot program stored in the hard disk device 112 are executed, and the operating system 201 is started up by the BIOS program and the boot program.

The group of programs 202 stores a program executing the function of the prediction result visualizing apparatus 100 therein, and the program is loaded and executed by the CPU 101. The group of files 203 stores information, data, a signal value, a variable value, or a parameter indicative of the processing result of the CPU 101 therein as each item of the file.

The file is recorded in the recording medium such as the hard disk device 112 or a memory. The information, the data, the signal value, the variable value, or the parameter recorded in the recording medium such as the hard disk device 112 or the memory is loaded into a main memory or a cache memory by the CPU 101, and is used for typical operations of the CPU 101, such as extraction, search, reference, comparison, computing, processing, edition, output, print, and display. For example, during the operations of the CPU 101, the information, the data, the signal value, the variable values, or the parameter is temporarily stored in a main memory, a register, a cache memory, a buffer memory, or the like.

The function of the prediction result visualizing apparatus 100 may be achieved by firmware stored in the ROM 102, or may be achieved by only software, only typical hardware such as an element, a device, a board (substrate), and a wiring, a combination of the software and the hardware, or a combination with the firmware. The firmware and the software are recorded as programs in a typical recoding medium such as the hard disk device 112, a removable disk, a CD-ROM, or a DVD-ROM. The program is loaded and executed by the CPU 101. That is, by the program, a computer is functioned as the prediction result visualizing apparatus 100.

As described above, the prediction result visualizing apparatus 100 is a computer including the CPU 101 as the processing device, the hard disk device 112 or the memory as the storage device, the keyboard 105, the mouse 106 and the communication board 107 as the input device, and the display 104, the printer 110, and the communication board 107 as the output device. The function of the prediction result visualizing apparatus 100 is achieved by use of the processing device, the storage device, the input device, and the output device.

### <<<Functional Block Configuration>>>

Next, a functional block configuration of the prediction result visualizing apparatus 100 will be described.

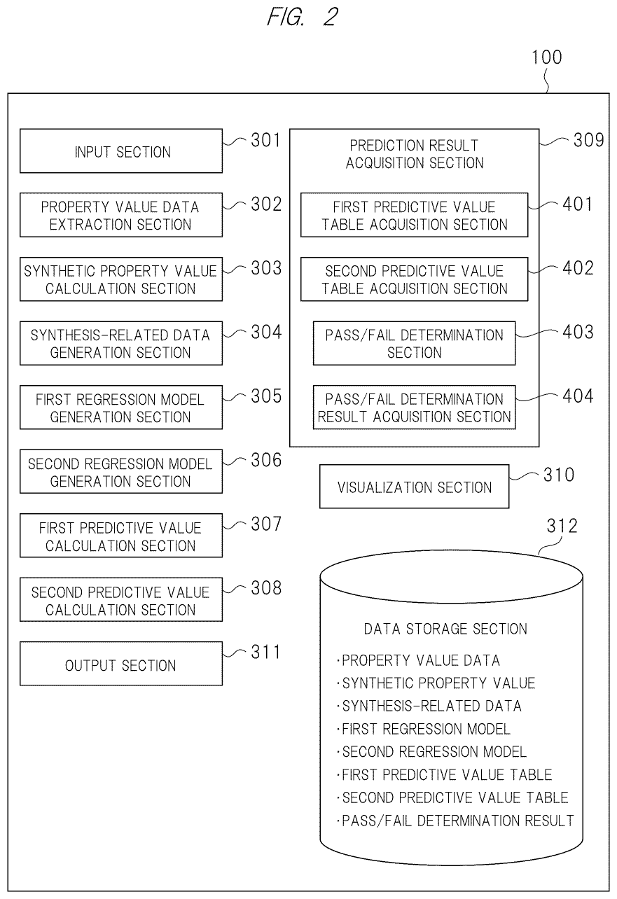

FIG. 2 is a functional block diagram of the prediction result visualizing apparatus 100.

The prediction result visualizing apparatus 100 includes an input section 301, a property value data extraction section 302, a synthetic property value calculation section 303, a synthesis-related data generation section 304, a first regression model generation section 305, a second regression model generation section 306, a first predictive value calculation section 307, a second predictive value calculation section 308, a prediction result acquisition section 309, a visualization section 310, an output section 311, and a data storage section 312.

The input section 301 is configured to input a property value data. The term “property value data” described here means data indicating correspondence between the material name and a property value of the material for each of a plurality of different materials. The property value data input by the input section 301 is stored in the data storage section 312. The data storage section 312 functions as a database configured to store a plurality of items of property value data.

The input section 301 is configured to input the blend data and the physical quantity data of the composite material containing two or more constituent materials belonging to the plurality of different materials. The term “blend data” described here is data including the material name and the blend rate of the constituent materials making the composite material, and may be also called blend information. On the other hand, the term “physical quantity data” is data indicating the already-known value of the physical quantity of the composite material as the physical quantity value, and acquired by experiments. The blend data and the physical quantity data input by the input section 301 are also stored in the data storage section 312.

The property value data extraction section 302 is configured to extract the property value data corresponding to the constituent material contained in the composite material, from among a plurality of items of property value data stored in the data storage section 312. For example, when the constituent materials contained in the composite material are “polyolefin” and “polyethylene”, the property value data extraction section 302 is configured to extract the property value data corresponding to the “polyolefin” and the property value data corresponding to the “polyethylene” from among the items of property value data.

The synthetic property value calculation section 303 is configured to calculate a synthesizing property value of the composite material by performing a computing for synthesizing a property value corresponding to the constituent material making the composite material on the basis of the blend rate included in the blend data input by the input section 301 and the property value included in the property value data extracted by the property value data extraction section 302.

For example, it is assumed that the composite material contains a constituent material with a property value of and a constituent material with a property value of as the constituent materials of the composite material and has a blend rate of “50:50” in the constituent materials. In this case, the synthetic property value calculation section 303 is configured to derive a synthetic property value of “62.5” by performing synthesis computing of “[50]×0.5+×0.5=[62.5]”.

The synthetic property value includes, for example, synthetic melting heat of the composite material, a synthetic melt flow rate of the composite material, or the like.

The synthesis-related data generation section 304 is configured to generate synthesis-related data indicating correspondence between the synthetic property value calculated in the synthetic property value calculation section 303 and the physical quantity value of the composite material (the “physical quantity data” of the composite material). The synthesis-related data is generated for the composite material that is input by the input section 301 and that has the already-known corresponding physical quantities. For example, when the physical quantity value of the composite material in the above example is [150], the synthesis-related data generation section 304 generates the synthesis-related data to indicate correspondence between the synthetic property value of [62.5] and the physical quantity value of [150]. The generated synthesis-related data is stored in the data storage section 312.

In the present embodiment described here, it is assumed that the physical quantities are a plurality of types of physical quantities. In particular, in the present embodiment, it is assumed as a specific example that the physical quantities are two physical quantities that are different from each other. That is, in the present embodiment, it is assumed that the physical quantities are a first physical quantity and a second physical quantity. For example, “initial tensile strength (initial TS)” is assumed as the first physical quantity. On the other hand, “initial elongation (initial TE)” is assumed as the second physical quantity.

In this case, the synthesis-related data generated in the synthesis-related data generation section 304 includes data indicating correspondence between the synthetic property value calculated in the synthetic property value calculation section 303 and the value of the first physical quantity of the composite material, and data indicating correspondence between the synthetic property value calculated in the synthetic property value calculation section 303 and the value of the second physical quantity of the composite material.

The first regression model generation section 305 has a function to generate the first regression model on the basis of the synthesis-related data (data indicating the correspondence between the synthetic property value and the value of the first physical quantity) generated in the synthesis-related data generation section 304. That is, the first regression model generation section 305 is configured to generate the first regression model to make the correspondence between the synthetic property value and the value of the first physical quantity.

That is, the first regression model generation section 305 is configured to generate the first regression model by using machine learning using a plurality of items of first learning data indicating the correspondence between the blend information of the already-known composite material having the already-known value of the first physical quantity and the already-known value of the second physical quantity and the value of the first physical quantity of the already-known composite material, and using the synthetic property value of the already-known composite material calculated by the synthetic property value calculation section 303.

Specifically, the first regression model generation section 305 generates the first regression model receiving the blend information and the synthetic property value as its input and outputting the value of the first physical quantity while using the blend information and the synthesis-related data (data indicating the correspondence between the synthetic property value and the value of the first physical quantity) as teaching data.

The “first regression model” described here is defined as a function to output a first predictive value as the value of the first physical quantity depending on the blend information and the synthetic property value in response to the input of the blend information and the synthetic property value. That is, the “first regression model” is defined as a function to output the first predictive value (predictive value of the first physical quantity) which is predicted to be achieved by an unknown composite material in response to input of the blend information and the synthetic property value of the unknown composite material having an unknown correspondence with the value of the first physical quantity. In this manner, it can be said that the first regression model is the function used to calculate the first predictive value of the unknown composite material having the unknown correspondence with the value of the first physical quantity.

The second regression model generation section 306 has a function to generate the second regression model on the basis of the synthesis-related data (data indicating the correspondence between the synthetic property value and the value of the second physical quantity) generated in the synthesis-related data generation section 304. That is, the second regression model generation section 306 is configured to generate the second regression model making the correspondence between the synthetic property value and the value of the second physical quantity.

That is, the second regression model generation section 306 is configured to generate the second regression model by using machine learning using a plurality of items of second learning data indicating correspondence between the blend information of the already-known composite material and the value of the second physical quantity of the already-known composite material and using the synthetic property value of the already-known composite material calculated by the synthetic property value calculation section 303.

Specifically, the second regression model generation section 306 generates the second regression model receiving the blend information and the synthetic property value as its input and outputting the value of the second physical quantity while using the blend information and the synthesis-related data (data indicating the correspondence between the synthetic property value and the value of the second physical quantity) as teaching data.

The second regression model” described here is defined as a function to output a second predictive value as the value of the second physical quantity depending on the blend information and the synthetic property value in response to the input of the blend information and the synthetic property value. That is, the “second regression model” is defined as a function to output the second predictive value (predictive value of the second physical quantity) which is predicted to be achieved by an unknown composite material in response to input of the blend information and the synthetic property value of the unknown composite material having an unknown correspondence with the value of the second physical quantity. In this manner, it can be said that the second regression model is the function used to calculate the second predictive value of the unknown composite material having the unknown correspondence with the value of the second physical quantity.

The first predictive value calculation section 307 is configured to calculate the first predictive value of the first physical quantity of the unknown composite material on the basis of the synthetic property value, the blend information including the material name and the blend rate of the constituent materials contained in the unknown composite material, and the first regression model.

The second predictive value calculation section 308 is configured to calculate the second predictive value of the second physical quantity of the unknown composite material on the basis of the synthetic property value, the blend information including the material name and the blend rate of the constituent materials contained in the unknown composite material, and the second regression model.

The prediction result acquisition section 309 is configured to acquire a prediction result which is based on a plurality of first predictive values calculated by the first predictive value calculation section 307 while changing the blend rate and a plurality of second predictive values calculated by the second predictive value calculation section 308 while changing the blend rate and which is corresponded to the changed blend rate.

The prediction result acquisition section 309 includes a first predictive value table acquisition section 401, a second predictive value table acquisition section 402, a pass/fail determination section 403, and a pass/fail determination result acquisition section 404.

The first predictive value table acquisition section 401 is configured to acquire a first predictive value table indicating correspondence between the blend rate and each of the plurality of first predictive values calculated by the first predictive value calculation section 307 while changing the blend rate. For example, it is assumed that the unknown composite material contains a first constituent material and a second constituent material. In this case, the first predictive value table is configured of a table with a plurality of cells, and each of the cells is specified by a value allocated on a first axis for the blend rate of the first constituent material and a value allocated on a second axis for the blend rate of the second constituent material. The first predictive value is displayed on each of the cells.

The second predictive value table acquisition section 402 is configured to acquire a second predictive value table indicating correspondence between the blend rate and each of the plurality of second predictive values calculated by the second predictive value calculation section 308 while changing the blend rate. For example, it is assumed that the unknown composite material contains a first constituent material and a second constituent material. In this case, the second predictive value table is configured of a table with a plurality of cells, and each of the cells is specified by a value allocated on a first axis for the blend rate of the first constituent material and a value allocated on a second axis for the blend rate of the second constituent material. The second predictive value is displayed on each of the cells.

The pass/fail determination section 403 is configured to determine whether each of the first predictive values passes or fails with reference to a target value of the first physical quantity and to determine whether each of the second predictive values passes or fails with reference to a target value of the second physical quantity. For example, when a lower limit value and an upper limit value are set for the target value of the first physical quantity, the pass/fail determination section 403 determines that a first predictive value within a range between the lower limit value and the upper limit value among the first predictive values passes, and determines that a first predictive value out of the range between the lower limit value and the upper limit value among the first predictive values fails.

Similarly, when a lower limit value and an upper limit value are set for the targe value of the second physical quantity, the pass/fail determination section 403 determines that a second predictive value within the range between the lower limit value and the upper limit value among the second predictive values passes, and determines that a second predictive value out of the range between the lower limit value and the upper limit value among the second predictive values fails.

The pass/fail determination result acquisition section 404 is configured to acquire the pass/fail determination result determined by the pass/fail determination section 403. For example, it is assumed that the unknown composite material contains a first constituent material and a second constituent material. In this case, the pass/fail determination result is configured of the pass/fail determination table with the plurality of cells, and each of the cells is specified by a value allocated on a first axis for the blend rate of the first constituent material and a value allocated on a second axis for the blend rate of the second constituent material. When it is determined that both the first predictive value and the second predictive value pass, “pass” is displayed on each of the cells. Otherwise, “fail” is displayed thereon.

The visualization section 310 is configured to visualize the range of the blend rate in which both the first predictive value and the second predictive value pass, on the basis of the pass/fail determination result. For example, it is assumed that the unknown composite material contains a first constituent material and a second constituent material. In this case, the pass/fail determination result is configured of the pass/fail determination table with the plurality of cells, and each of the cells is specified by a value allocated on a first axis for the blend rate of the first constituent material and a value allocated on a second axis for the blend rate of the second constituent material. In this case, whether both the first predictive value and the second predictive value pass is visualized on each of the cells at a glance.

The output section 311 outputs the pass/fail determination result visualized by the visualization section 310.

The data storage section 312 is configured to store various types of data. For example, the data storage section 312 is configured to store the property value data, the synthetic property value, the synthesis-related data, the first regression model, the second regression model, the first predictive value table, the second predictive value table, the pass/fail determination result, and the like.

The prediction result visualizing apparatus 100 is configured as described above.

### <<Operations of Prediction Result Visualizing Apparatus>>

The prediction result visualizing apparatus 100 according to the first specific aspect is configured as described above, and its operations will be described below. The operations of the prediction result visualizing apparatus 100 are a “regression model generating operation” and a “pass/fail determination result visualizing operation.”

The operations will be described below.

### <<<Regression Model Generating Operation>>>

In the first specific aspect, the first regression model and the second regression model are generated.

First, the first regression model generating operation will be described.

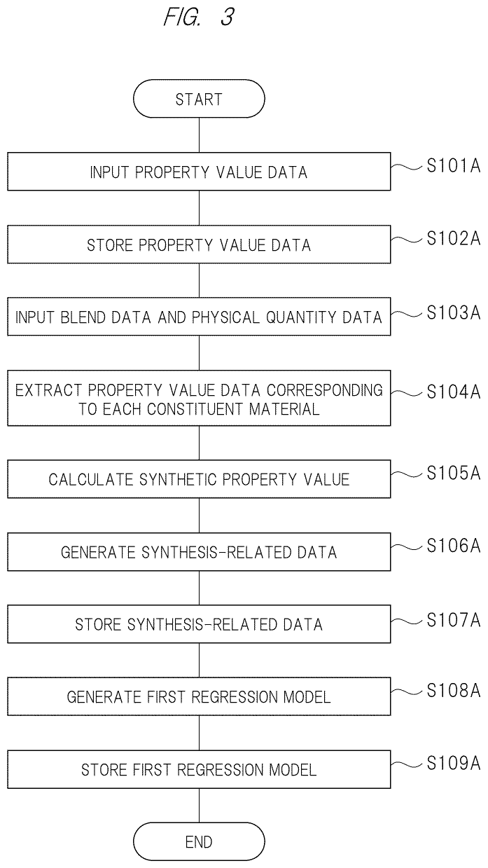

FIG. 3 is a flowchart for explaining the first regression model generating operation.

In FIG. 3, the input section 301 inputs the plurality of items of property value data indicating the correspondence between the material name and the property value of the material for each of a plurality of different materials (S101A). Then, the items of property value data input by the input section 301 are stored in the data storage section 312 (S102A).

Next, the input section 301 inputs the blend data (blend information) and the physical quantity data of the already-known composite material which contains two or more materials as the constituent materials and which has the already-known corresponding first physical quantity value (S103A).

Then, the property value data extraction section 302 extracts the property value data corresponding to the constituent material contained in the already-known composite material from among the items of property value data stored in the data storage section 312 (S104A). Subsequently, on the basis of the blend data input from the input section 301, the synthetic property value calculation section 303 calculates the synthetic property value of the already-known composite material by performing computing for synthesizing the property value of the property value data extracted by the property value data extraction section (S105A).

Then, the synthesis-related data generation section 304 generates the synthesis-related data indicating the correspondence between the synthetic property value calculated by the synthetic property value calculation section 303 and the value of the first physical quantity (physical quantity data) of the already-known composite material (S106A). Then, the synthesis-related data generated by the synthesis-related data generation section 304 is stored in the data storage section 312 (S107A).

Next, the first regression model generation section 305 generates the first regression model on the basis of the synthesis-related data generated by the synthesis-related data generation section 304 (S108A). Specifically, the first regression model generation section 305 generates the first regression model receiving the blend information and the synthetic property value as its input and outputting the value of the first physical quantity while using the synthesis-related data as teaching data.

Then, the first regression model generated by the first regression model generation section 305 is stored in the data storage section 312 (S109A). The first regression model is generated as described above.

Note that the property value data is previously stored in the data storage section 312. In response to the input of the blend data (blend information) and the physical quantity data of a new already-known composite material, the synthesis-related data corresponding to the new already-known composite material may be automatically generated and stored in the data storage section 312. That is, in response to the input of the blend data (blend information) and the physical quantity data of the new already-known composite material, a database related to the synthesis-related data may be automatically updated. Then, the first regression model is generated to receive the blend information and the synthetic property value as its input and output the value of the first physical quantity while using the updated database related to the synthesis-related data as teaching data.

Next, the second regression model generating operation will be described.

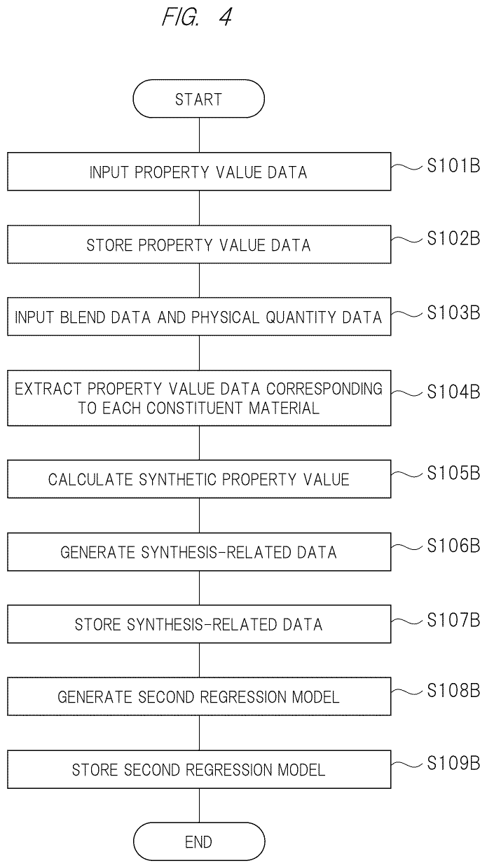

FIG. 4 is a flowchart for explaining the second regression model generating operation.

In FIG. 4, the input section 301 inputs the plurality of items of property value data indicating the correspondence between the material name and the property value of the material for each of a plurality of different materials (S101B). Then, the items of property value data input by the input section 301 are stored in the data storage section 312 (S102B).

Next, the input section 301 inputs the blend data (blend information) and the physical quantity data of the already-known composite material which contains two or more materials as the constituent materials and which has the already-known corresponding second physical quantity value (S103B).

Then, the property value data extraction section 302 extracts the property value data corresponding to the constituent material contained in the already-known composite material from among the items of property value data stored in the data storage section 312 (S104B). Subsequently, on the basis of the blend data input from the input section 301, the synthetic property value calculation section 303 calculates the synthetic property value of the already-known composite material by performing computing for synthesizing the property value of the property value data extracted by the property value data extraction section (S105B).

Then, the synthesis-related data generation section 304 generates the synthesis-related data indicating the correspondence between the synthetic property value calculated by the synthetic property value calculation section 303 and the value of the second physical quantity (physical quantity data) of the already-known composite material (S106B). Then, the synthesis-related data generated by the synthesis-related data generation section 304 is stored in the data storage section 312 (S107B).

Next, the second regression model generation section 306 generates the second regression model on the basis of the synthesis-related data generated by the synthesis-related data generation section 304 (S108B). Specifically, the second regression model generation section 306 generates the second regression model receiving the blend information and the synthetic property value as its input and outputting the value of the second physical quantity while using the synthesis-related data as teaching data.

Then, the second regression model generated by the second regression model generation section 306 is stored in the data storage section 312 (S109B). The second regression model is generated as described above.

Note that the property value data is previously stored in the data storage section 312. In response to the input of the blend data (blend information) and the physical quantity data of a new already-known composite material, the synthesis-related data corresponding to the new already-known composite material may be automatically generated and stored in the data storage section 312. That is, in response to the input of the blend data (blend information) and the physical quantity data of the new already-known composite material, a database related to the synthesis-related data may be automatically updated. Then, the second regression model is generated to receive the blend information and the synthetic property value as its input and output the value of the second physical quantity while using the updated database related to the synthesis-related data as teaching data.

### <<<Pass/Fail Determination Result Visualizing Operation>>>

Next, the pass/fail determination result visualizing operation will be described.

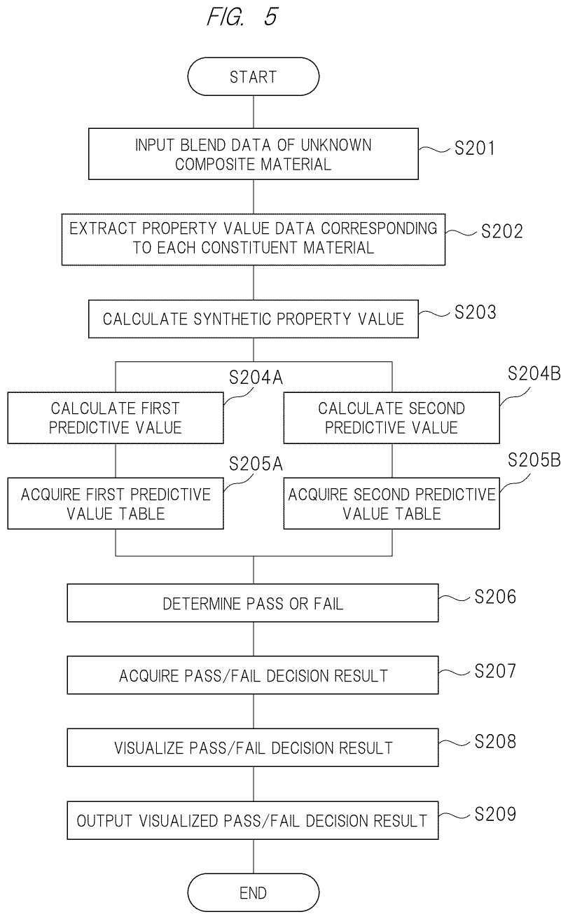

FIG. 5 is a flowchart for explaining the pass/fail determination result visualizing operation. Note that the first regression model and the second regression model are previously stored in the data storage section 312.

In FIG. 5, first, the input section 301 inputs the blend data (blend information) of the unknown composite material whose correspondence with the value of the first physical quantity and the value of the second physical quantity is unknown (S201).

Next, the property value data extraction section 302 extracts the property value data corresponding to the constituent material contained in the unknown composite material from among the items of property value data stored in the data storage section 312 (S202).

Subsequently, the synthetic property value calculation section 303 calculates the synthetic property value of the unknown composite material by performing computing for synthesizing the property values of the property value data extracted by the property value data extraction section 302, on the basis of the blend data of the unknown composite material input from the input section 301 (S203).

Then, the first predictive value calculation section 307 calculates the first predictive value of the first physical quantity of the unknown composite material on the basis of the synthetic property value of the unknown composite material, the blend data including the material name and the blend rate of the constituent material contained in the unknown composite material, and the first regression model (S204A).

Similarly, the second predictive value calculation section 308 calculates the second predictive value of the second physical quantity of the unknown composite material on the basis of the synthetic property value of the unknown composite material, the blend data including the material name and the blend rate of the constituent material contained in the unknown composite material, and the second regression model (S204B).

Next, the first predictive value table acquisition section 401 acquires the first predictive value table indicating correspondence between the blend rate and each of the first predictive values calculated by the first predictive value calculation section 307 while changing the blend rate (S205A).

Similarly, the second predictive value table acquisition section 402 acquires the second predictive value table indicating correspondence between the blend rate and each of the second predictive values calculated by the second predictive value calculation section 308 while changing the blend rate (S205B).

Subsequently, the pass/fail determination section 403 determines whether each of the first predictive values passes or fails with reference to the target value of the first physical quantity, and determines whether each of the second predictive values passes or fails with reference to the target value of the second physical quantity (S206).

Then, the pass/fail determination result acquisition section 404 acquires the pass/fail determination result determined by the pass/fail determination section 403 (S207). Then, on the basis of the pass/fail determination result, the visualization section 310 visualizes the range of the blend rate in which both the first predictive value and the second predictive value pass (S208), and the output section 311 outputs the visualized pass/fail determination result (S209). As described above, the visualized pass/fail determination result can be acquired by the prediction result visualizing apparatus 100 according to the first specific aspect.

### <<Prediction Result Visualizing Program>>

A prediction result visualizing method performed in the prediction result visualizing apparatus 100 can be achieved by a prediction result visualizing program causing a computer to execute a processing of visualizing the prediction result of the first physical quantity and the prediction result of the second physical quantity.

For example, in the prediction result visualizing apparatus 100 configured of the computer shown in FIG. 1, a prediction result visualizing program according to the first specific aspect can be introduced as one of the group of programs 202 stored in the hard disk device 112. The prediction result visualizing program is executed by the computer that is the prediction result visualizing apparatus 100 to achieve the prediction result visualizing method according to the first specific aspect.

The prediction result visualizing program causing the computer to execute each processing of creating data for the prediction result visualizing processing can be recorded and distributed in a computer-readable recording medium. Such recording mediums include magnetic storage mediums typified by a hard disk and a flexible disk, optical storage mediums typified by CD-ROM and DVD-ROM, hardware devices typified by nonvolatile memories such as ROM and EEPROM.

### Modification Example

In the first specific aspect, as shown in FIG. 2, the example in which the prediction result visualizing system for visualizing the prediction result of the physical quantity of the composite material containing two or more materials belonging to the plurality of different materials as the constituent materials is configured of the single prediction result visualizing apparatus 100 has been described. However, the prediction result visualizing system is not configured of only the above configuration, and may be configured of, for example, a distributed system.

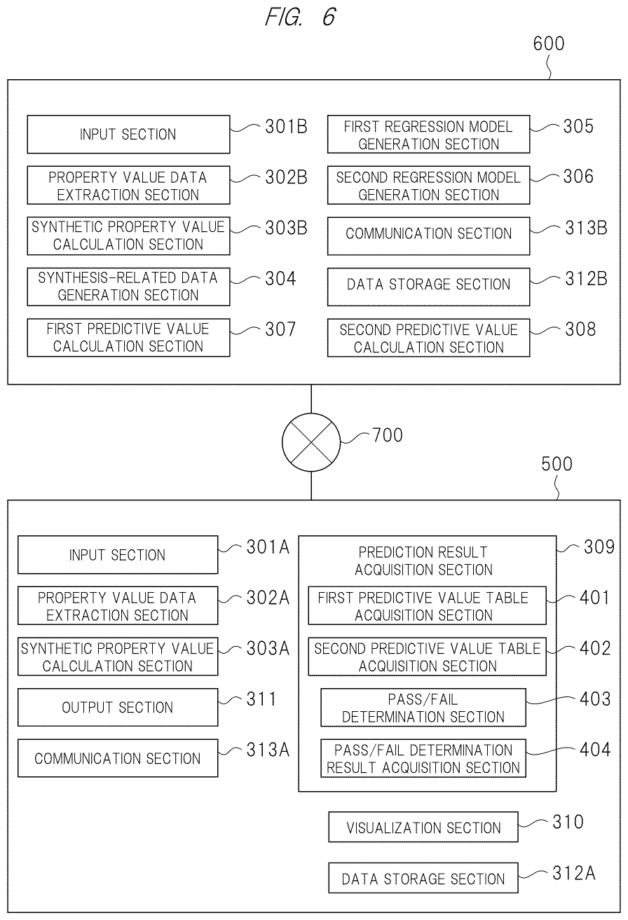

FIG. 6 is a functional block diagram showing an example in which the prediction result visualizing system is configured of a prediction result visualizing apparatus and a regression model generating apparatus.

As shown in FIG. 6, the prediction result visualizing system is configured of a prediction result visualizing apparatus 500 and a regression model generating apparatus 600, and the prediction result visualizing apparatus 500 and the regression model generating apparatus 600 are connected to each other via, for example, a network 700.

The prediction result visualizing apparatus 500 includes an input section 301A, a property value data extraction section 302A, a synthetic property value calculation section 303A, the prediction result acquisition section 309, the visualization section 310, the output section 311, a data storage section 312A, and a communication section 313A.

The regression model generating apparatus 600 includes an input section 301B, a property value data extraction section 302B, a synthetic property value calculation section 303B, the synthesis-related data generation section 304, the first regression model generation section 305, the second regression model generation section 306, the first predictive value calculation section 307, the second predictive value calculation section 308, a data storage section 312B, and a communication section 313B.

The prediction result visualizing apparatus 500 and the regression model generating apparatus 600 configured as described above are configured to transmit/receive data to/from each other by using the communication section 313A and the communication section 313B via the network 700. The regression model generating apparatus 600 performs the “regression model generating operation” to generate the first regression model and the second regression model.

To the contrary, the prediction result visualizing apparatus 500 outputs the blend data (blend information) of the unknown composite material and the synthetic property value calculated by the synthetic property value calculation section 303A, to the regression model generating apparatus 600. Then, the prediction result visualizing apparatus 500 receives an output result (the first predictive value of the first physical quantity) as its input from the regression model generating apparatus 600, the output result being output from the first regression model in response to the input of the blend data and the synthetic property value of the unknown composite material into the first regression model in the regression model generating apparatus 600, and stores the result into the data storage section 312A.

Similarly, the prediction result visualizing apparatus 500 receives an output result (the second predictive value of the second physical quantity) as its input from the regression model generating apparatus 600, the output result being output from the second regression model in response to the input of the blend data and the synthetic property value of the unknown composite material into the second regression model in the regression model generating apparatus 600, and stores the result into the data storage section 312A.

Then, the prediction result visualizing apparatus 500 performs the “pass/fail determination result visualizing operation” on the basis of the output result input from the regression model generating apparatus 600. In this manner, the prediction result visualizing system according to the first specific aspect can be also configured of the distribution system including the prediction result visualizing apparatus 500 and the regression model generating apparatus 600.

### <<Specific Example>>

Subsequently, a specific example will be described.

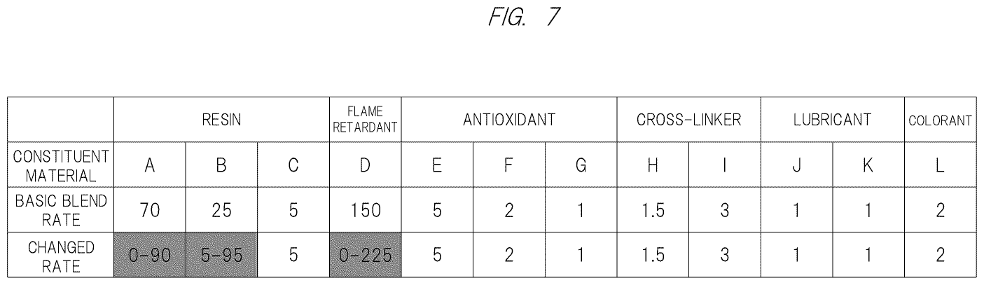

FIG. 7 is a table indicating the constituent material and the blend rate of the composite material used in the specific example.

In FIG. 7, the composite material used in the specific example contains two or more materials belonging to the plurality of different materials as the constituent materials. For example, the composite material is made of resin A, resin B, resin C, a flame retardant D, an antioxidant E, an antioxidant F, an antioxidant G, a cross-linker H, a cross-linker I, a lubricant J, a lubricant K, and a colorant L. FIG. 7 shows the basic blend rate of the composite material. In the specific example, the predictive value of the physical quantity in a case of change of the blend rates of the resin A, the resin B and the flame retardant D from the basic blend rate is calculated.

The blend rate of the resin A is changed from 0 part by mass to 90 parts by mass relative to (100 parts by mass of) the total resin made of the resin A, the resin B and the resin C. The blend rate of the resin B is changed from 5 parts by mass to 95 parts by mass relative to (100 parts by mass of) the total resin. The blend rate of the flame-retardant D is changed from 0 part by mass to 225 parts by mass relative to (100 parts by mass of) the total resin.

The physical quantity described here includes the first physical quantity and the second physical quantity. For example, the first physical quantity is an “initial tensile strength (initial TS)” while the second physical quantity is “initial elongation (initial TE).”

First, the first regression model is used to calculate the first predictive value of the “initial tensile strength (initial TS)” that is the first physical quantity. And, the second regression model is used to calculate the second predictive value of the “initial elongation (initial TE)” that is the second physical quantity.

It is assumed that the first regression model and the second regression model are previously generated as described in the “regression model generating operation.” Each of the first regression model and the second regression model has, for example, 29 explanation variables for the types of the constituent materials making the composite material and nine explanation variables for the synthetic property values. That is, the explanation variables for the types of the constituent materials (explanation variables for the blend data) include 29 1 constituent materials typified by resin, flame retardant, antioxidant, cross-linker, lubricant, colorant, and the like. To the contrary, the explanation variables for the synthetic property values include, for example, filler volume fraction, polymer volume fraction, filler volume/polymer volume, presence/absence of silane surface treatment, presence/absence of fatty acid surface treatment, filler surface area, an amount of vinyl acetate group, a denaturation amount of maleic anhydride, and an amount of crystal.

Note that an objective variable of the first regression model is the first predictive value of the “initial tensile strength (initial TS)” that is the first physical quantity, and an objective variable of the second regression model is the second predictive value of the “initial elongation (initial TE)” that is the second physical quantity.

Under the above description as the precondition, the pass/fail determination result visualizing operation is performed in the specific example.

### 1. Step S201

In FIG. 5, first, the input section 301 inputs the blend data (blend information) of the unknown composite material whose correspondence with the value of the “initial tensile strength (initial TS)” and the value of the “initial elongation (initial TE)” is unknown (S201). For example, the blend data of the unknown composite material of FIG. 7 is input to the input section 301, the blend data indicating 90 parts by mass of the resin A, 5 parts by mass of the resin B, 5 parts by mass of the resin C, 225 parts by mass of the flame retardant D, 5 parts by mass of the antioxidant E, 2 parts by mass of the antioxidant F, 1 part by mass of the antioxidant G, 1.5 parts by mass of the cross-linker H, 3 parts by mass of the cross-linker I, 1 part by mass of the lubricant J, 1 part by mass of the lubricant K, and 2 parts by mass of the colorant L. Note that the blend data of the unknown composite material of FIG. 7 is input to the input section 301, the blend rate being obtained while changing the blend rate of the resin A from 0 part by mass to 90 parts by mass, changing the blend rate of the resin B from 5 parts by mass to 95 parts by mass, and changing the blend rate of the flame-retardant D from 0 part by mass to 225 parts by mass.

### 2. Step S202

Next, the property value data extraction section 302 extracts the property value data corresponding to the constituent material contained in the unknown composite material from among the items of property value data stored in the data storage section 312. Specifically, the property value data corresponding to the relevant constituent material among the constituent materials (the resins A to C, the flame retardant D, the antioxidants E to G, the cross-linkers H and I, the lubricants J and K, and the colorant L) contained in the unknown composite material of FIG. 7 is extracted depending on the type of the property value. For example, when the property value is the filler volume fraction, the resin and the flame retardant (filler) are relevant. Thus, the property value of each of the resins (resins A to C) and the property value of the flame retardant (flame retardant D) shown in FIG. 7 are extracted from among the constituent materials making the unknown composite material.

### 3. Step S203

Subsequently, the synthetic property value calculation section 303 calculates the synthetic property value of the unknown composite material by performing computing for synthesizing the property values of the property value data extracted by the property value data extraction section 302, on the basis of the blend data of the unknown composite material input by the input section 301. For example, the synthetic property value in the specific example includes five typical synthetic property values described below, and the synthetic property value calculation section 303 performs computing for calculating the synthetic property values.

### (1) Filler Volume Fraction

The filler volume fraction indicates a rate of the volume of the filler (flame retardant) relative to the volume of the resin (base polymer), and is a parameter indicating how much rate of the filler relative to the resin is added. For example, the resin and the filler are relevant to the synthetic property value for the filler volume fraction. Thus, computing is performed for calculating the synthetic property value on the basis of the property values of the resin (resin A to C) and the flame-retardant (flame retardant D) shown in FIG. 7 among the constituent materials of the unknown composite material, and the blend data input by the input section 301.

### (2) Denaturation Amount of Maleic Anhydride

The denaturation amount of maleic anhydride is a parameter indicating the amount of maleic anhydride (MAH) contained in the unknown composite material. Since the maleic anhydride has a function to adhere the resin and the filler, the amount of maleic anhydride is thought to affect the elongation or the tensile strength of the resin composite, and thus, is used as the parameter. For example, the resin is relevant to the synthetic property value for the denaturation amount of maleic anhydride. Thus, the computing for calculating the synthetic property value is performed based on the blend data input to the input section 301 and each property value of the resins (resins A to C) shown in FIG. 7 among the constituent materials making the unknown composite material.

### (3) Amount of Crystal

The amount of crystal is a parameter indicating the amount of crystalline resin contained in the composite material. Since hardness of the composite material changes depending on the amount of crystalline resin, the amount of crystalline resin is thought to affect the elongation or the tensile strength of the resin composite, and thus, is used as the parameter. For example, the resin is relevant to the synthetic property value for the amount of crystal. Thus, the computing for calculating the synthetic property value is performed based on the blend data input to the input section 301 and each property value of the resins (resins A to C) shown in FIG. 7 among the constituent materials making the unknown composite material.

### (4) Amount of Vinyl Acetate Group

The amount of vinyl acetate group is a parameter indicating the amount of vinyl acetate group contained in the unknown composite material. Since hardness of the unknown composite material changes depending on the amount of vinyl acetate group, the amount of vinyl acetate group is thought to affect the elongation or the tensile strength of the resin composite, and thus, is used as the parameter. For example, the resin is relevant to the synthetic property value for the amount of crystal. Thus, the computing for calculating the synthetic property value is performed based on the blend data input to the input section 301 and each property value of the resins (resins A to C) shown in FIG. 7 among the constituent materials making the unknown composite material.

### (5) Filler Surface Area

The filler surface area is used as a parameter indicating the size of the filler particle used as a flame retardant or flame retardant promoter. The size of the filler particle is thought to affect the elongation or the tensile strength of the resin composite, and thus, is used as the parameter. For example, the flame retardant is relevant to the synthetic property value for the filler surface area. Thus, the computing for calculating the synthetic property value is performed based on the blend data input to the input section 301 and the property value of the flame retardant (flame retardant D) shown in FIG. 7 among the constituent materials making the unknown composite material.

### 4-1. Step S204A

Next, the first predictive value calculation section 307 calculates the first predictive value of the “initial tensile strength (initial TS)” of the unknown composite material, on the basis of the synthetic property value of the unknown composite material calculated in step S203, the blend data including the material name and the blend rate of the constituent material contained in the unknown composite material, and the first regression model. Specifically, the first predictive value of the “initial tensile strength (initial TS)” of the unknown composite material is output from the first regression model in response to the input of the synthetic property value of the unknown composite material calculated in step S203 and the blend data including the material name and the blend rate of the constituent material contained in the unknown composite material to the first regression model.

### 4-2. Step S204B

Similarly, the second predictive value calculation section 308 calculates the second predictive value of the “initial elongation (initial TE)” of the unknown composite material, on the basis of the synthetic property value of the unknown composite material calculated in step S203, the blend data including the material name and the blend rate of the constituent material contained in the unknown composite material, and the second regression model. Specifically, the second predictive value of the “initial elongation (initial TE)” of the unknown composite material is output from the second regression model in response to the input of the synthetic property value of the unknown composite material calculated in step S203 and the blend data including the material name and the blend rate of the constituent material contained in the unknown composite material to the second regression model.

### 5-1. Step S205A

Next, the first predictive value of the “initial tensile strength (initial TS)” for each of the plurality of blend rates is calculated on the basis of the first regression model by repetitive execution of the above-described steps S201 to S204A while changing the blend data including the blend rate of the constituent material contained in the unknown composite material. For example, the first predictive value of the “initial tensile strength (initial TS)” is calculated on the basis of the first regression model, the “initial tensile strength (initial TS)” corresponding to the blend rate of the resin A changed from 0 part by mass to 90 parts by mass, the blend rate of the resin B changed from 5 parts by mass to 95 parts by mass, and the blend rate of the flame retardant D changed from 0 part by mass to 225 parts by mass.

The first predictive value table acquisition section 401 acquires the first predictive value table indicating correspondence between the blend rate and each of the first predictive values calculated by the first predictive value calculation section 307 while changing the blend rate.

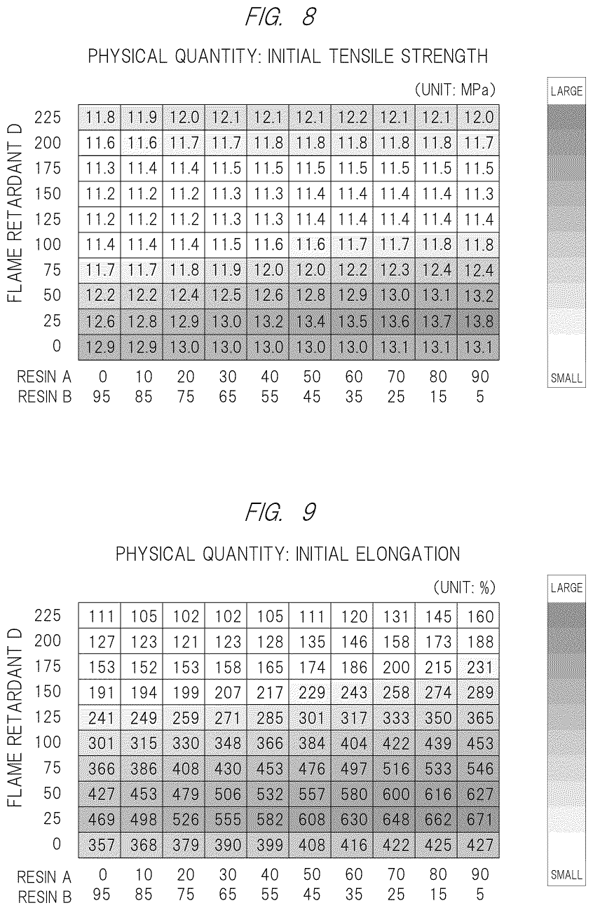

FIG. 8 is a table indicating an exemplary first predictive value table.

The first predictive value table is configured of, for example, a two-dimensional table with a plurality of cells, and each of the cells is specified by a value allocated on the horizontal axis for the blend rate of the resin A and the blend rate of the resin B and a value allocated on the vertical axis for the blend rate of the flame retardant D. A first predictive value (numerical value) of the “initial tensile strength (initial TS)” is displayed on each of the cells. In an example, “11.4 (Mpa)” is displayed as the first predictive value of the “initial tensile strength (initial TS)” on the cell specified by the value (50 parts by mass) allocated on the horizontal axis for the blend rate of the resin A, the value (45 parts by mass) allocated on the horizontal axis for the blend rate of the resin B, and the value (150 parts by mass) allocated on the vertical axis for the blend rate of the flame retardant D.

For example, as shown in FIG. 8, the “heatmap display” is used for the first predictive value table to show the magnitude of the “initial tensile strength (initial TS)”. The “heatmap display” requires a sufficient amount of data. However, in the specific example, the above-described “heatmap display” can be achieved by use of the first regression model since a large number of first predictive values can be acquired instead of the experimental data which is originally difficult to be acquired.

As shown in FIG. 8, as exemplary “heatmap display”, for example, emphasis display based on color density in which the larger the number is, the denser the color is, is exemplified. By the use of such “heatmap display”, the tendency (magnitudes) of the first predictive values corresponding to the different blend rates can be recognized at a glance. Consequently, the desired blend rate can be easily determined with reference to the “heatmap display.”

### 5-2. Step S205B

Similarly, the second predictive value of the “initial elongation (initial TE)” for each of the plurality of blend rates is calculated on the basis of the second regression model by repetitive execution of the above-described steps S201 to S204B while changing the blend data including the blend rate of the constituent material contained in the unknown composite material. For example, the second predictive value of the “initial elongation (initial TE)” is calculated on the basis of the second regression model, the “initial elongation (initial TE)” corresponding to the blend rate of the resin A changed from 0 part by mass to 90 parts by mass, the blend rate of the resin B changed from 5 parts by mass to 95 parts by mass, and the blend rate of the flame retardant D changed from 0 part by mass to 225 parts by mass.

The second predictive value table acquisition section 402 acquires the second predictive value table indicating correspondence between the blend rate and each of the second predictive values calculated by the second predictive value calculation section 308 while changing the blend rate.

FIG. 9 is a table indicating an exemplary second predictive value table.

The second predictive value table is configured of, for example, a two-dimensional table with a plurality of cells, and each of the cells is specified by a value allocated on the horizontal axis for the blend rate of the resin A and the blend rate of the resin B and a value allocated on the vertical axis for the blend rate of the flame retardant D. A second predictive value (%) of the “initial elongation (initial TE)” is displayed on each of the cells. In an example, “229(%)” is displayed as the second predictive value of the “initial elongation (initial TE)” on the cell specified by the value (50 parts by mass) allocated on the horizontal axis for the blend rate of the resin A, the value (45 parts by mass) allocated on the horizontal axis for the blend rate of the resin B, and the value (150 parts by mass) allocated on the vertical axis for the blend rate of the flame retardant D.

For example, as shown in FIG. 9, the “heatmap display” is used for the second predictive value table to show the magnitude of the “initial elongation (initial TE)”. The “heatmap display” requires a sufficient amount of data. However, in the specific example, the above-described “heatmap display” can be achieved by use of the first regression model since a large number of second predictive values can be acquired instead of the experimental data which is originally difficult to be acquired.

As shown in FIG. 9, as exemplary “heatmap display”, for example, emphasis display based on color density in which the larger the number is, the denser the color is, is exemplified. By the use of such “heatmap display”, the tendency (magnitudes) of the second predictive values corresponding to the different blend rates can be recognized at a glance. Consequently, the desired blend rate can be easily determined with reference to the “heatmap display.”

### 6. Step S206

Subsequently, the pass/fail determination section 403 determines whether each of the first predictive values passes or fails with reference to the target value of the “initial tensile strength (initial TS)”, and determines whether each of the second predictive values passes or fails with reference to the target value of the “initial elongation (initial TE)”.

Pay attention to, for example, the pass/fail determination for the “initial tensile strength (initial TS)”. A lower limit value and an upper limit value are set as the target value of the “initial tensile strength (initial TS)”. If the first predictive value of the “initial tensile strength (initial TS)” falls within the range between the lower limit value and the upper limit value, the pass/fail determination section 403 determines that the first predictive value of the “initial tensile strength (initial TS)” passes. To the contrary, if the first predictive value of the “initial tensile strength (initial TS)” does not fall within the range between the lower limit value and the upper limit value, the pass/fail determination section 403 determines that the first predictive value of the “initial tensile strength (initial TS)” fails.

It is determined whether each of the first predictive values passes or fails with reference to the target value of the “initial tensile strength (initial TS)” as described above. For example, each of the first predictive values is determined to pass or fail for each of the entire cells (100 cells) configuring the first predictive value table shown in FIG. 8.

Similarly, pay attention to, for example, the pass/fail determination for the “initial elongation (initial TE)”. A lower limit value and an upper limit value are set as the target value of the “initial elongation (initial TE)”. If the second predictive value of the “initial elongation (initial TE)” falls within the range between the lower limit value and the upper limit value, the pass/fail determination section 403 determines that the second predictive value of the “initial elongation (initial TE)” passes. To the contrary, if the second predictive value of the “initial elongation (initial TE)” does not fall within the range between the lower limit value and the upper limit value, the pass/fail determination section 403 determines that the second predictive value of the “initial elongation (initial TE)” fails.

It is determined whether each of the second predictive values passes or fails with reference to the target value of the “initial elongation (initial TE)” as described above. For example, each of the second predictive values is determined to pass or fail for each of the entire cells (100 cells) configuring the second predictive value table shown in FIG. 9.

### 7. Step S207

Then, the pass/fail determination result acquisition section 404 acquires the pass/fail determination result determined by the pass/fail determination section 403.

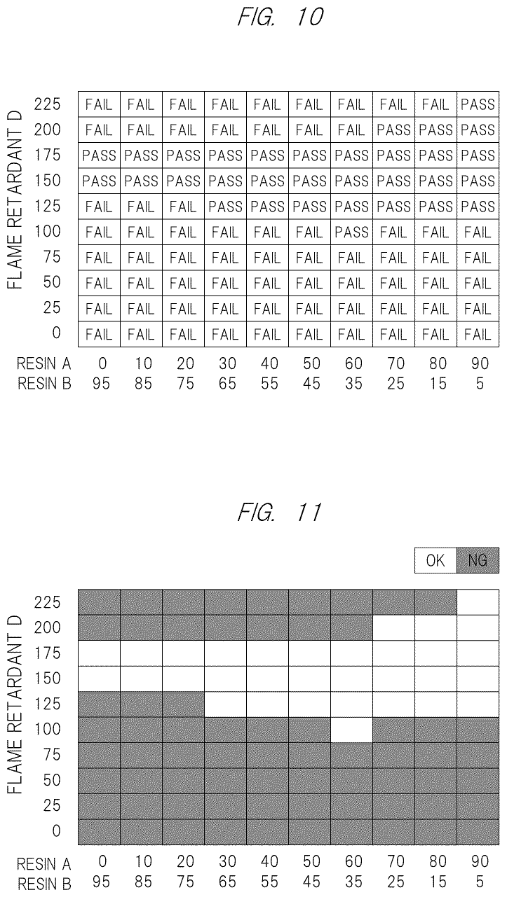

FIG. 10 is a table indicating the exemplary pass/fail determination result.

The pass/fail determination result is configured of, for example, a two-dimensional table with a plurality of cells, and each of the cells is specified by a value allocated on the horizontal axis for the blend rate of the resin A and the blend rate of the resin B and a value allocated on the vertical axis for the blend rate of the flame retardant D. In this case, “pass” is displayed on each of the cells if both the first predictive value and the second predictive value pass. Otherwise, “fail” is displayed thereon.

In an example, “pass” is displayed on the cell specified by the value (50 parts by mass) allocated on the horizontal axis for the blend rate of the resin A, the value (45 parts by mass) allocated on the horizontal axis for the blend rate of the resin B, and the value (150 parts by mass) allocated on the vertical axis for the blend rate of the flame retardant D. This means that it is determined that both the first predictive value and the second predictive value pass for the unknown composite material having the blend rate of the resin A of “50 parts by mass,” the blend rate of the resin B of “45 parts by mass,” and the blend rate of the flame retardant D of “150 parts by mass.”

In another example, “fail” is displayed on the cell specified by the value (0 part by mass) allocated on the horizontal axis for the blend rate of the resin A, the value (95 parts by mass) allocated on the horizontal axis for the blend rate of the resin B, and the value (225 parts by mass) allocated on the vertical axis for the blend rate of the flame retardant D. This means that both the first predictive value and the second predictive value are determined not to pass but to fail for the unknown composite material having the blend rate of the resin A of “0 part by mass,” the blend rate of the resin B of “95 parts by mass,” and the blend rate of the flame retardant D of “225 parts by mass.”

### 8. Step S208

Subsequently, on the basis of the pass/fail determination result, the visualization section 310 visualizes the range of the blend rate making both the first predictive value and the second predictive value pass.

FIG. 11 is a table indicating an exemplary visualized pass/fail determination result.

The visualized pass/fail determination result is configured of a pass/fail determination table with a plurality of cells, and each of the cells is specified by a value allocated on the horizontal axis for the blend rate of the resin A and the blend rate of the resin B and a value allocated on the vertical axis for the blend rate of the flame retardant D. In this case, on each of the cells, a result indicating that both the first predictive value and the second predictive value are determined to pass or fail is visualized at a glance. Specifically, in the visualized pass/fail determination result shown in FIG. 11, a cell having a result indicating that both the first predictive value and the second predictive value are determined to pass is displayed as a white cell region. To the contrary, a cell having a result indicating that both the first predictive value and the second predictive value are determined to fail is displayed as a gray region cell. Since the pass/fail determination result is visualized by such display, the blend rate making both the first predictive value and the second predictive value pass can be understandably displayed. That is, since the pass/fail determination result is visualized, the blend rate having the physical quantities all satisfying the predetermined conditions can be recognized at a glance. Thus, the blend rate of the unknown composite material satisfying the predetermined conditions can be easily selected.

### 9. Step S209

Next, the output section 311 outputs the visualized pass/fail determination result. In this manner, according to the specific example, the pass/fail determination result in which the blend rate having the physical quantities all satisfying the predetermined conditions is understandably visualized can be acquired.

### <<Feature of First Specific Aspect>>

Subsequently, a feature of the first specific aspect will be described.

For example, in an example of the wire coating material containing resin or blending agents as the composite material, initial tensile strength (TS), initial elongation (TE), aging retention, oilproof retention (tensile strength), oilproof retention (elongation), anti-fuel retention (tensile strength), anti-fuel retention (elongation), and low-temperature elongation are exemplified as the plurality of physical quantities. All the physical quantities need to satisfy the predetermined conditions in order to manufacture the wire coating material as an excellent-quality product.

In this regard, in the first specific aspect, the predictive values of the plurality of physical quantities are calculated by use of the regression models in changing the blend rate, and the pass/fail determination results of the predictive values corresponding to the physical quantities are acquired on the basis of the calculated predictive values.

A feature of the first specific aspect is that the blend rate of the composite material having the physical quantities all satisfying the predetermined conditions is visualized. In other words, the feature is that the range of the blend rate in which both the predictive values pass is visualized on the basis of the pass/fail determination result. In this manner, the blend rate having the physical quantities all satisfying the predetermined conditions can be recognized at a glance, and thus, the blend rate of the composite material satisfying the predetermined conditions can be easily selected.

For example, FIG. 10 is a table showing an exemplary pass/fail determination result. In the pass/fail determination result shown in FIG. 10, it is difficult to understandably recognize the blend rate at which both the first predictive value and the second predictive value are determined to pass. To the contrary, FIG. 11 is a table showing an exemplary visualized pass/fail determination result. In the visualized pass/fail determination result shown in FIG. 11, a cell having a result indicating that both the first predictive value and the second predictive value are determined to pass is displayed as a white cell region. To the contrary, a cell having a result indicating that both the first predictive value and the second predictive value are not determined to pass is displayed as a gray region cell. Since the pass/fail determination result is visualized by such display, the blend rate making both the first predictive value and the second predictive value pass can be understandably displayed. That is, since the pass/fail determination result is visualized, the blend rate having the physical quantities all satisfying the predetermined conditions can be recognized at a glance. Thus, the blend rate of the unknown composite material satisfying the predetermined conditions can be easily selected.

Note that the explanation in the first specific aspect is about the example of the visualization of the pass/fail determination result for the combination of two physical quantities that are the “initial tensile strength (TS)” and the “initial elongation (TE)”. However, this idea can be extended to an aspect of the visualization of the pass/fail determination result for a combination of two or more physical quantities such as eight physical quantities (initial tensile strength (TS), initial elongation (TE), aging retention, oilproof retention (tensile strength), oilproof retention (elongation), anti-fuel retention (tensile strength), anti-fuel retention (elongation), and low-temperature elongation) as the plurality of physical quantities.

### <Second Specific Aspect>

The present embodiment is under the precondition that the predictive value of the physical quantity is acquired by use of the regression model. In this regard, in the first specific aspect, the output (objective variable) from the regression model is the predictive value made of the pinpoint numerical value. To the contrary, explanation in the second specific aspect is about an example in which a pinpoint numerical value and a standard deviation are used as the outputs from the regression model. That is, the explanation in the second specific aspect is about an example under a precondition that the physical quantity is predicted by use of distribution in which the output from the regression model has variation.

For example, a model that is called Gaussian process regression model is exemplified as the regression model. The Gaussian process regression model has a function to output the distribution, and can output a predictive value that is a pinpoint mean value and a standard deviation for determining the range of the distribution. The explanation in the second specific aspect is made about an example of use of the Gaussian process regression model as the regression model and use of the mean value (predictive value) and the standard deviation output from the Gaussian process regression model as a method of evaluating the plurality of physical quantities. Note that the components similar to those in the first specific aspect will not be described, and differences between the first and second specific aspects will be mainly described.

### <<Configuration of Prediction Result Visualizing Apparatus>>

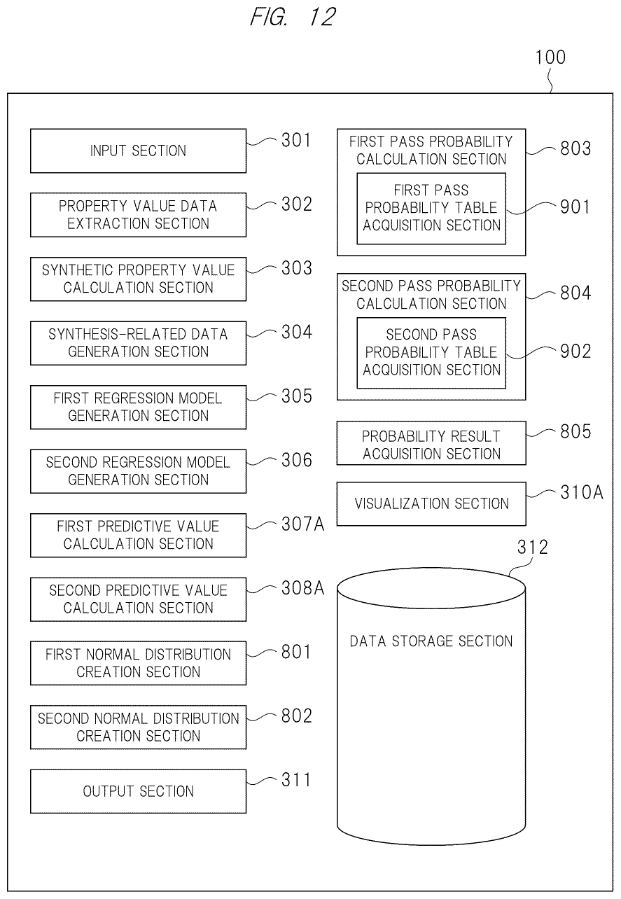

FIG. 12 is a functional block diagram of the prediction result visualizing apparatus 100 according to the second specific aspect.

In FIG. 12, the prediction result visualizing apparatus 100 includes a first predictive value calculation section 307A, a second predictive value calculation section 308A, a first normal distribution creation section 801, a second normal distribution creation section 802, a first pass probability calculation section 803, a second pass probability calculation section 804, a probability result acquisition section 805, and a visualization section 310A that are sections achieving functions different from those in the first specific aspect.

The “first regression model” generated by the first regression model generation section is the Gaussian process regression model, and the “first regression model” is a function to output a first predictive value of a first physical quantity and a first standard deviation of the first predictive value in response to input of the synthetic property value and the blend information of the unknown composite material.

The “second regression model” generated by the second regression model generation section is the Gaussian process regression model, and the “second regression model” is a function to output a second predictive value of a second physical quantity and a second standard deviation thereof in response to input of the synthetic property value and the blend information of the unknown composite material.

The first predictive value calculation section 307A is configured to calculate the first predictive value and the first standard deviation of the first physical quantity on the basis of the first regression model. The first predictive value calculation section 307A includes a first table acquisition section configured to acquire a first predictive value table indicating correspondence between the blend rate and each of the first predictive values calculated by the first predictive value calculation section 307A while changing the blend rate and a first standard deviation table indicating correspondence between the blend rate and each of the first standard deviations.

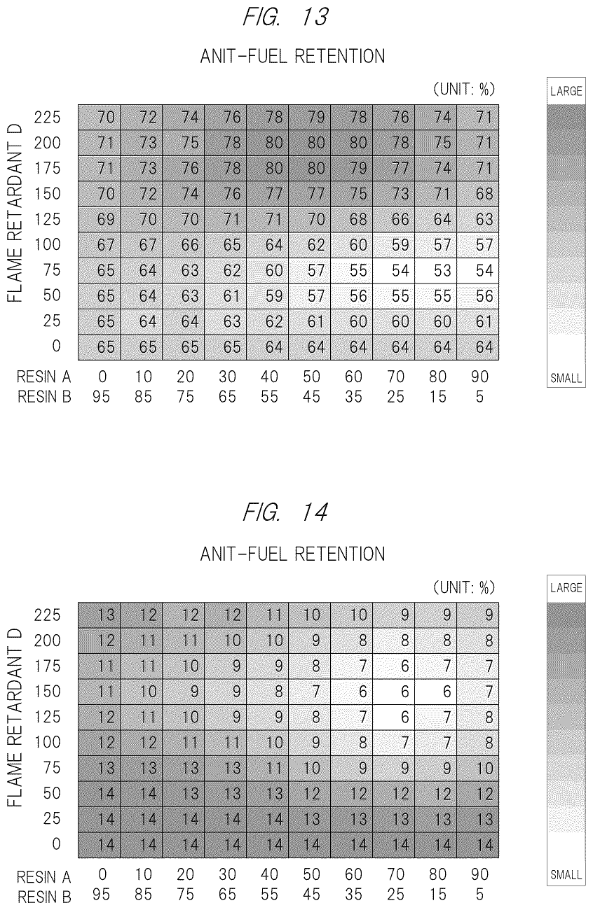

FIG. 13 is a table indicating an exemplary first predictive value table.

The first predictive value table is configured of, for example, a two-dimensional table with a plurality of cells, and each of the cells is specified by a value allocated on the horizontal axis for the blend rate of the resin A and the blend rate of the resin B and a value allocated on the vertical axis for the blend rate of the flame retardant D. A first predictive value (%) of “anti-fuel retention” is displayed on each of the cells. In an example, “77(%)” is displayed as the first predictive value of “anti-fuel retention” on the cell specified by the value (50 parts by mass) allocated on the horizontal axis for the blend rate of the resin A, the value (45 parts by mass) allocated on the horizontal axis for the blend rate of the resin B, and the value (150 parts by mass) allocated on the vertical axis for the blend rate of the flame retardant D.

For example, as shown in FIG. 13, the “heatmap display” is used for the first predictive value table to show the magnitude of the “anti-fuel retention”. The “heatmap display” requires a sufficient amount of data. However, in the specific example, the above-described “heatmap display” can be achieved by use of the first regression model since a large number of first predictive values can be acquired instead of the experimental data which is originally difficult to be acquired.

As shown in FIG. 13, as exemplary “heatmap display”, for example, emphasis display based on color density in which the larger the number is, the denser the color is, is exemplified. By the use of such “heatmap display”, the tendency (magnitudes) of the first predictive values corresponding to the different blend rates can be recognized at a glance.

FIG. 14 is a table showing an exemplary first standard deviation table.

The first standard deviation table is configured of, for example, a two-dimensional table with a plurality of cells, and each of the cells is specified by a value allocated on the horizontal axis for the blend rate of the resin A and the blend rate of the resin B and a value allocated on the vertical axis for the blend rate of the flame retardant D. A first standard deviation (%) of “anti-fuel retention” is displayed on each of the cells. In an example, “7(%)” is displayed as the first deviation of “anti-fuel retention” on the cell specified by the value (50 parts by mass) allocated on the horizontal axis for the blend rate of the resin A, the value (45 parts by mass) allocated on the horizontal axis for the blend rate of the resin B, and the value (150 parts by mass) allocated on the vertical axis for the blend rate of the flame retardant D.

For example, as shown in FIG. 14, the “heatmap display” is used for the first standard deviation table to show the magnitude of the “anti-fuel retention”. The “heatmap display” requires a sufficient amount of data. However, in the specific example, the above-described “heatmap display” can be achieved by use of the first regression model since a large number of first deviations can be acquired instead of the experimental data which is originally difficult to be acquired.

As shown in FIG. 14, as exemplary “heatmap display”, for example, emphasis display based on color density in which the larger the number is, the denser the color is, is exemplified. By the use of such “heatmap display”, the tendency (magnitudes) of the first standard deviations corresponding to the different blend rates can be recognized at a glance.

The second predictive value calculation section 308A is configured to calculate the second predictive value and the second standard deviation of the second physical quantity on the basis of the second regression model. The second predictive value calculation section 308A includes a second table acquisition section configured to acquire a second predictive value table indicating correspondence between the blend rate and each of the second predictive values calculated by the second predictive value calculation section 308A while changing the blend rate and a second standard deviation table indicating correspondence between the blend rate and each of the second standard deviations.

As the second physical quantity, initial tensile strength (TS), initial elongation (TE), aging retention, oilproof retention (tensile strength), oilproof retention (elongation), and low-temperature elongation can be used. Note that examples of the second predictive value table and the second standard deviation table acquired by the second table acquisition section are basically similar to the first predictive value table and the first standard deviation table acquired by the first table acquisition section. In particular, the emphasis display such as “heatmap display” is used also for the second predictive value table and the second standard deviation table.

Next, the first normal distribution creation section 801 is configured to create a first normal distribution in which the mean value is the first predictive value while a variance is the square of the first standard deviation, on the basis of the first predictive value and the first standard deviation calculated by the first predictive value calculation section 307A. For example, the first normal distribution is created for each of the 100 cells configuring the first predictive value table and the first standard deviation table, on the basis of FIGS. 13 and 14.

Similarly, the second normal distribution creation section 802 is configured to create a second normal distribution in which the mean value is the second predictive value while a variance is the square of the second standard deviation, on the basis of the second predictive value and the second standard deviation calculated by the second predictive value calculation section 308A. For example, the second normal distribution is created for each of the 100 cells configuring the second predictive value table and the second standard deviation table.

Subsequently, the first pass probability calculation section 803 is configured to calculate a first pass probability at the blend rate corresponding to the first predictive value, on the basis of the first normal distribution created by the first normal distribution creation section 801 and the target value of the first physical quantity (“anti-fuel retention”). The first pass probability calculation section 803 includes a first pass probability table acquisition section 901 configured to acquire a first pass probability table indicating correspondence between the blend rate and each of the first pass probabilities calculated by the first pass probability calculation section 803 while changing the blend rate.

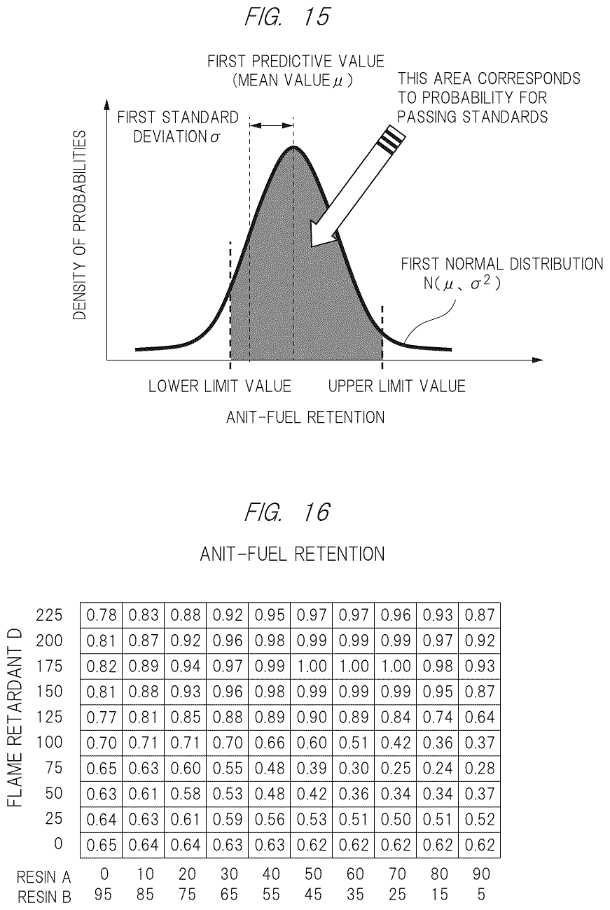

FIG. 15 is a diagram schematically showing a method of calculating the first pass probability.

In FIG. 15, the first normal distribution is distribution created by the first normal distribution creation section 801 on the basis of the first predictive value (mean value p) and the first standard deviation (o) calculated by the first predictive value calculation section 307A. In this case, when a lower limit value and an upper limit value are set as the target value of the first physical quantity (“anti-fuel retention”), an area of a gray region shown in FIG. 15 corresponds to the first pass probability. That is, the first pass probability calculation section 803 calculates the first pass probability by acquiring the area of the gray region shown in FIG. 15.

FIG. 16 is a table showing an exemplary first pass probability table.

The first pass probability table is configured of, for example, a two-dimensional table with a plurality of cells, and each of the cells is specified by a value allocated on the horizontal axis for the blend rate of the resin A and the blend rate of the resin B and a value allocated on the vertical axis for the blend rate of the flame retardant D. A first pass probability of “anti-fuel retention” is displayed on each of the cells. In an example, “0.99” is displayed as the first pass probability of “anti-fuel retention” on the cell specified by the value (50 parts by mass) allocated on the horizontal axis for the blend rate of the resin A, the value (45 parts by mass) allocated on the horizontal axis for the blend rate of the resin B, and the value (150 parts by mass) allocated on the vertical axis for the blend rate of the flame retardant D.

Similarly, the second pass probability calculation section 804 is configured to calculate a second pass probability at the blend rate corresponding to the second predictive value, on the basis of the second normal distribution created by the second normal distribution creation section 802 and the target value of the second physical quantity. The second pass probability calculation section 804 includes a second pass probability table acquisition section 902 configured to acquire a second pass probability table indicating correspondence between the blend rate and each of the second pass probabilities calculated by the second pass probability calculation section 804 while changing the blend rate.

Next, the probability result acquisition section 805 is configured to acquire a probability result which is corresponded to the changed blend rate and which is related to a multiplication probability obtained by multiplying the first pass probability calculated by the first pass probability calculation section 803 by the second pass probability calculated by the second pass probability calculation section 804. Note that the explanation described here is about the probability result for the combination (multiplication probability) of two physical quantities that are the first physical quantity (“anti-fuel retention”) and the (“optional”) second physical quantity. However, this idea can be extended to an aspect of the acquisition of the probability result for a combination (multiplication probability) of two or more physical quantities such as the above-described eight physical quantities (initial tensile strength (TS), initial elongation (TE), aging retention, oilproof retention (tensile strength), oilproof retention (elongation), anti-fuel retention (tensile strength), anti-fuel retention (elongation), and low-temperature elongation) as the plurality of physical quantities.

Therefore, the probability result will be described as the probability result for the combination (multiplication probability) of the eight physical quantities.

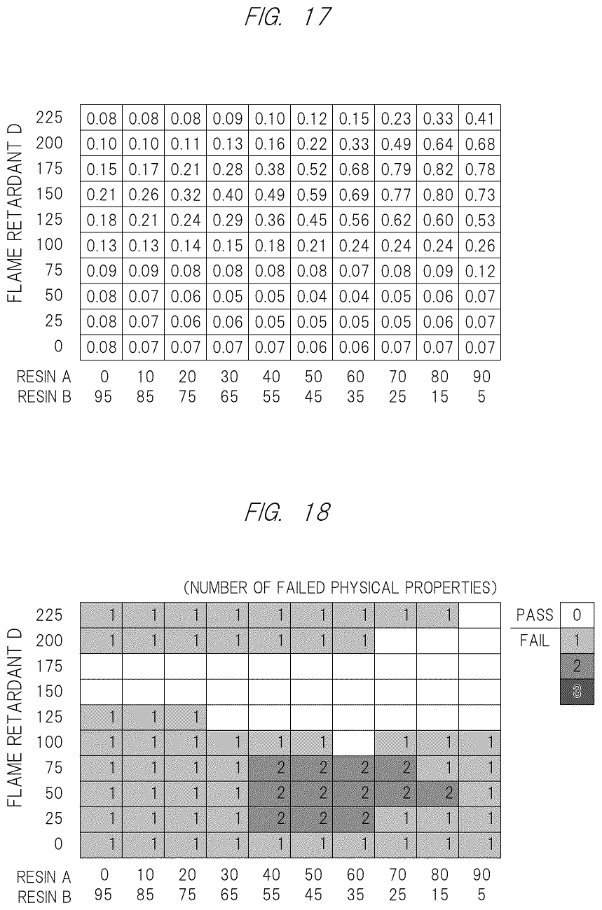

FIG. 17 is a table showing an exemplary probability result (probability result table).

The probability result is configured of, for example, a two-dimensional table with a plurality of cells, and each of the cells is specified by a value allocated on the horizontal axis for the blend rate of the resin A and the blend rate of the resin B and a value allocated on the vertical axis for the blend rate of the flame retardant D. A pass probability having the physical properties (eight physical properties) all satisfying the standards is displayed on each of the cells. In an example, “0.59” is displayed as the pass probability having the physical properties (eight physical properties) all satisfying the standards on the cell specified by the value (50 parts by mass) allocated on the horizontal axis for the blend rate of the resin A, the value (45 parts by mass) allocated on the horizontal axis for the blend rate of the resin B, and the value (150 parts by mass) allocated on the vertical axis for the blend rate of the flame retardant D.

Subsequently, the visualization section 310A is configured to visualize the probability result acquired by the probability result acquisition section 805.

For example, FIG. 18 is a table showing an exemplary probability result visualized by the visualization section 310A. A case of the multiplication probability that is equal to or larger than a predetermined threshold value is regarded as “pass”, and a “white region” is displayed. To the contrary, a case of the multiplication probability that is smaller than the predetermined threshold value is regarded as “fail”, and a “grey region” is displayed. On the failed cell, the number of the failed physical properties (physical quantities) among the eight physical properties (physical quantities) is also displayed. According to one aspect of such visualized probability result, the blend rate having the physical quantities all satisfying the predetermined requirements can be recognized at a glance, and thus, the blend rate of the composite material satisfying the predetermined conditions can be easily selected.

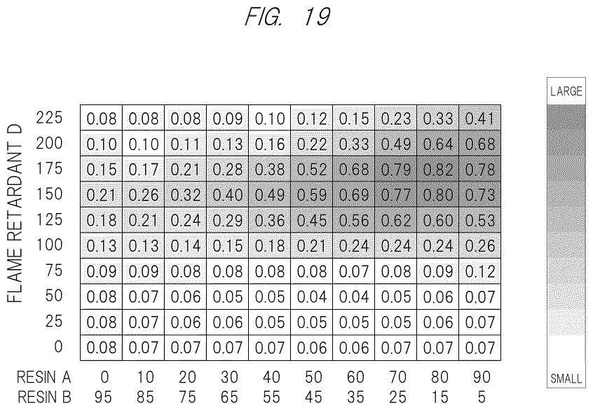

FIG. 19 is a table showing another exemplary probability result visualized by the visualization section 310A. The probability result shown in FIG. 19 is configured of, for example, a two-dimensional table with a plurality of cells, and each of the cells is specified by a value allocated on the horizontal axis for the blend rate of the resin A and the blend rate of the resin B and a value allocated on the vertical axis for the blend rate of the flame retardant D. A pass probability (numerical value) having the (eight) physical quantities all satisfying the standards is displayed on each of the cells. In an example, “0.59” is displayed as the pass probability having the (eight) physical properties all satisfying the standards on the cell specified by the value (50 parts by mass) allocated on the horizontal axis for the blend rate of the resin A, the value (45 parts by mass) allocated on the horizontal axis for the blend rate of the resin B, and the value (150 parts by mass) allocated on the vertical axis for the blend rate of the flame retardant D.

For example, as shown in FIG. 19, the “heatmap display” is used for the probability result to show the magnitude of the probability having the (eight) physical quantities all satisfying the standards. The “heatmap display” requires a sufficient amount of data. However, in the specific example, the above-described “heatmap display” can be achieved by use of the plurality of regression models since a large number of predictive values can be acquired instead of the experimental data which is originally difficult to be acquired.

As shown in FIG. 19, as exemplary “heatmap display”, for example, emphasis display based on color density in which the larger the number is, the denser the color is, is exemplified. By the use of such “heatmap display”, the tendency (magnitudes) of the probability having the (eight) physical quantities all satisfying the standards corresponding to the different blend rates can be recognized at a glance.

### <<Operations of Prediction Result Visualizing Apparatus>>

The prediction result visualizing apparatus 100 according to the second specific aspect is configured as described above, and operations thereof will be described below. The operations of the prediction result visualizing apparatus 100 include a “regression model generating operation” and a “pass/fail determination result visualizing operation.” However, the “regression model generating operation” is the same as that in the first specific aspect, and will not be described.

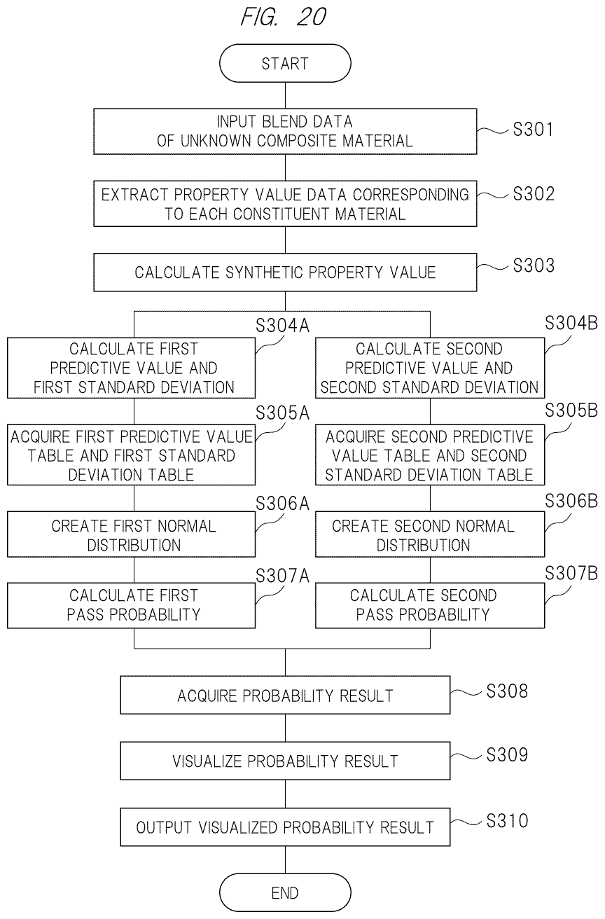

FIG. 20 is a flowchart for explaining the operations of the prediction result visualizing apparatus 100. Note that the first regression model and the second regression model are previously stored in the data storage section 312.

In FIG. 20, first, the input section 301 inputs the blend data (blend information) of the unknown composite material whose correspondence with the value of the first physical quantity and the value of the second physical quantity is unknown (S301).

Next, the property value data extraction section 302 extracts the property value data corresponding to the constituent material contained in the unknown composite material from among the items of property value data stored in the data storage section 312 (S302).

Subsequently, the synthetic property value calculation section 303 calculates the synthetic property value of the unknown composite material by performing computing for synthesizing the property values of the property value data extracted by the property value data extraction section 302, on the basis of the blend data of the unknown composite material input by the input section 301 (S303).

Then, the first predictive value calculation section 307A calculates the first predictive value and the first standard deviation of the first physical quantity of the unknown composite material, on the basis of the synthetic property value of the unknown composite material, the blend data including the material name and the blend rate of the constituent material contained in the unknown composite material, and the first regression model (S304A). Similarly, the second predictive value calculation section 308A calculates the second predictive value and the second standard deviation of the second physical quantity of the unknown composite material, on the basis of the synthetic property value of the unknown composite material, the blend data including the material name and the blend rate of the constituent material contained in the unknown composite material, and the second regression model (S304B).

Next, the first predictive value calculation section 307A acquires the first predictive value table indicating correspondence between the blend rate and each of the first predictive values calculated by the first predictive value calculation section 307A while changing the blend rate. The first predictive value calculation section 307A further acquires the first standard deviation table indicating correspondence between the blend rate and each of the first standard deviations calculated by the first predictive value calculation section 307A while changing the blend rate (S305A).

Similarly, the second predictive value calculation section 308A acquires the second predictive value table indicating correspondence between the blend rate and each of the second predictive values calculated by the second predictive value calculation section 308A while changing the blend rate. The second predictive value calculation section 308A further acquires the second standard deviation table indicating correspondence between the blend rate and each of the second standard deviations calculated by the second predictive value calculation section 308A while changing the blend rate (S305B).

The first normal distribution creation section 801 is configured to create a first normal distribution in which the mean value is the first predictive value while a variance is the square of the first standard deviation, on the basis of the first predictive value and the first standard deviation calculated by the first predictive value calculation section 307A.

Similarly, the second normal distribution creation section 802 is configured to create a second normal distribution in which the mean value is the second predictive value while a variance is the square of the second standard deviation, on the basis of the second predictive value and the second standard deviation calculated by the second predictive value calculation section 308A.

Then, the first pass probability calculation section 803 calculates the first pass probability at the blend rate corresponding to the first predictive value, on the basis of the first normal distribution created by the first normal distribution creation section 801 and the target value of the first physical quantity (“anti-fuel retention”), and acquires the first pass probability table indicating correspondence between the blend rate and each of the first pass probabilities calculated by the first pass probability calculation section 803 while changing the blend rate (S307A).

Similarly, the second pass probability calculation section 804 calculates the second pass probability at the blend rate corresponding to the second predictive value, on the basis of the second normal distribution created by the second normal distribution creation section 802 and the target value of the second physical quantity, and acquires the second pass probability table indicating correspondence between the blend rate and each of the second pass probabilities calculated by the second pass probability calculation section 804 while changing the blend rate (S307B).

Next, the probability result acquisition section 805 acquires a probability result which is corresponded to the changed blend rate and which is related to a multiplication probability obtained by multiplying the first pass probability calculated by the first pass probability calculation section 803 by the second pass probability calculated by the second pass probability calculation section 804 (S308). Then, the visualization section 310A visualizes the probability result acquired by the probability result acquisition section 805 (S309). Then, the output section 311 outputs the visualized probability result (S310). In this manner, according to the prediction result visualizing apparatus 100 in the second specific aspect, the visualized probability result can be acquired.

In the foregoing, the invention made by the inventors of the present application has been concretely described on the basis of the embodiments. However, it is needless to say that the present invention is not limited to the foregoing embodiments, and various modifications and alterations can be made within the scope of the present invention.

The explanation in the embodiment is about the aspect of the use of the first regression model for outputting the first predictive value of the first physical quantity in response to the input of the synthetic property value and the blend information and the second regression model for outputting the second predictive value of the second physical quantity in response to the input of the synthetic property value and the blend information.

However, the technical idea of the embodiment is not limited to the above, and is also widely applicable to, for example, an aspect of the use of the first regression model for outputting the first predictive value of the first physical quantity in response to the input of the blend information and the second regression model for outputting the second predictive value of the second physical quantity in response to the input of the blend information without the use of the synthetic property values.

What is claimed is:

1. A prediction result visualizing apparatus visualizing a prediction result of a physical quantity of a composite material containing two or more materials belonging to a plurality of different materials as constituent materials, comprising:
a first predictive value calculation section configured to calculate a first predictive value of a first physical quantity of an unknown composite material on basis of a first regression model and blend information including a material name and a blend rate of a constituent material contained in the unknown composite material having an unknown value of the first physical quantity and an unknown value of a second physical quantity;
a second predictive value calculation section configured to calculate a second predictive value of the second physical quantity of the unknown composite material on basis of a second regression model and the blend information including the material name and the blend rate of the constituent material contained in the unknown composite material;
a prediction result acquisition section configured to acquire a prediction result which is based on a plurality of first predictive values calculated by the first predictive value calculation section while changing the blend rate and a plurality of second predictive values calculated by the second predictive value calculation section while changing the blend rate and which is corresponded to the changed blend rate; and
a visualization section configured to visualize the prediction result,
wherein the first regression model is a function to output the first predictive value of the first physical quantity in response to input of the blend information, and
the second regression model is a function to output the second predictive value of the second physical quantity in response to input of the blend information.

2. The prediction result visualizing apparatus according to claim 1, further comprising:
a synthetic property value calculation section configured to calculate a synthetic property value of the unknown composite material, on basis of the blend rate of the constituent material contained in the unknown composite material and a property value of the constituent material contained in the unknown composite material,
wherein the first predictive value calculation section calculates the first predictive value of the first physical quantity of the unknown composite material, on basis of the synthetic property value, the blend information, and the first regression model,
the second predictive value calculation section calculates the second predictive value of the second physical quantity of the unknown composite material, on basis of the synthetic property value, the blend information, and the second regression model,
the first regression model is a function to output the first predictive value of the first physical quantity in response to input of the synthetic property value and the blend information, and
the second regression model is a function to output the second predictive value of the second physical quantity in response to input of the synthetic property value and the blend information.

3. The prediction result visualizing apparatus according to claim 2, further comprising:
a first regression model generation section configured to generate the first regression model; and
a second regression model generation section configured to generate the second regression model.

4. The prediction result visualizing apparatus according to claim 3,
wherein the first regression model generation section generates the first regression model by using machine learning using a plurality of items of first learning data indicating correspondence between blend information of an already-known composite material having an already-known value of the first physical quantity and an already-known value of the second physical quantity and a value of the first physical quantity of the already-known composite material, and using a synthetic property value of the already-known composite material calculated by the synthetic property value calculation section, and
the second regression model generation section generates the second regression model by using machine learning using a plurality of items of second learning data indicating correspondence between the blend information of the already-known composite material and a value of the second physical quantity of the already-known composite material, and using a synthetic property value of the already-known composite material calculated by the synthetic property value calculation section.

5. The prediction result visualizing apparatus according to claim 1,
wherein the prediction result acquisition section includes a pass/fail determination section configured to determine whether each of the plurality of first predictive values passes or fails with reference to a target value of the first physical quantity and to determine whether each of the plurality of second predictive values passes or fails with reference to a target value of the second physical quantity,
the prediction result is a pass/fail determination result determined by the pass/fail determination section, and
the visualization section visualizes a range of a blend rate at which both the first predictive value and the second predictive value pass, on basis of the pass/fail determination result.

6. The prediction result visualizing apparatus according to claim 5,
wherein the unknown composite material contains a first constituent material and a second constituent material as the constituent materials,
the pass/fail determination result is configured of a pass/fail determination table with a plurality of cells,
each of the plurality of cells is specified by a value allocated on a first axis for a blend rate of the first constituent material and a value allocated on a second axis for a blend rate of the second constituent material, and
a result indicating that both the first predictive value and the second predictive value pass is displayed on each of the plurality of cells.

7. The prediction result visualizing apparatus according to claim 2,
wherein the first regression model is a function to output the first predictive value and a first standard deviation of the first physical quantity in response to input of the synthetic property value and the blend information,
the second regression model is a function to output the second predictive value and a second standard deviation of the second physical quantity in response to input of the synthetic property value and the blend information,
the first predictive value calculation section calculates the first predictive value and the first standard deviation of the first physical quantity, on basis of the first regression model, the second predictive value calculation section calculates the second predictive value and the second standard deviation of the second physical quantity, on basis of the second regression model,
the prediction result visualizing apparatus further includes:
a first normal distribution creation section configured to create a first normal distribution in which a mean value is the first predictive value while a variance is the square of the first standard deviation, on basis of the first predictive value and the first standard deviation;
a second normal distribution creation section configured to create a second normal distribution in which a mean value is the second predictive value while a variance is the square of the second standard deviation, on basis of the second predictive value and the second standard deviation;
a first pass probability calculation section configured to calculate a first pass probability at a blend rate corresponding to the first predictive value, on basis of the first normal distribution and a target value of the first physical quantity; and
a second pass probability calculation section configured to calculate a second pass probability at a blend rate corresponding to the second predictive value, on basis of the second normal distribution and a target value of the second physical quantity,
the prediction result is a probability result which is corresponded to the changed blend rate and which is related to a multiplication probability obtained by multiplying the first pass probability by the second pass probability, and
the visualization section visualizes the probability result.

8. The prediction result visualizing apparatus according to claim 7,
wherein the unknown composite material contains a first constituent material and a second constituent material,
the probability result is configured of a probability table with a plurality of cells,
each of the plurality of cells is specified by a value allocated on a first axis for a blend rate of the first constituent material and a value allocated on a second axis for a blend rate of the second constituent material,
the multiplication probability is displayed on each of the plurality of cells, and
a cell on which a multiplication probability that is larger in value than a first value among the plurality of cells is displayed to be emphasized.

9. A prediction result visualizing method of causing a computer to visualize a prediction result of a physical quantity of a composite material containing two or more materials belonging to a plurality of different materials as constituent materials, comprising steps of:
a first predictive value calculation step of causing the computer to calculate a first predictive value of a first physical quantity of an unknown composite material on basis of a first regression model and blend information including a material name and a blend rate of a constituent material contained in the unknown composite material having an unknown value of the first physical quantity and an unknown value of a second physical quantity;
a second predictive value calculation step of causing the computer to calculate a second predictive value of the second physical quantity of the unknown composite material on basis of a second regression model and the blend information including the material name and the blend rate of the constituent material contained in the unknown composite material;
a prediction result acquisition step of causing the computer to acquire a prediction result which is based on a plurality of first predictive values calculated by the first predictive value calculation step while changing the blend rate and a plurality of second predictive values calculated by the second predictive value calculation step while changing the blend rate and which is corresponded to the changed blend rate; and
a visualization step of causing the computer to visualize the prediction result,
wherein the first regression model is a function to output the first predictive value of the first physical quantity in response to input of the blend information, and
the second regression model is a function to output the second predictive value of the second physical quantity in response to input of the blend information.

10. A prediction result visualizing apparatus visualizing a prediction result of a physical quantity of a composite material containing two or more materials belonging to a plurality of different materials as constituent materials, comprising:
a first predictive value input section configured to input a first predictive value of a first physical quantity of an unknown composite material calculated on basis of a first regression model and blend information including a material name and a blend rate of a constituent material contained in the unknown composite material having an unknown value of the first physical quantity and an unknown value of a second physical quantity;
a second predictive value input section configured to input a second predictive value of the second physical quantity of the unknown composite material calculated on basis of a second regression model and the blend information including the material name and the blend rate of the constituent material contained in the unknown composite material;
a prediction result acquisition section configured to acquire a prediction result which is based on a plurality of first predictive values calculated while changing the blend rate and input by the first predictive value input section and a plurality of second predictive values calculated while changing the blend rate and input by the second predictive value input section and which is corresponded to the changed blend rate; and
a visualization section configured to visualize the prediction result,
wherein the first regression model is a function to output the first predictive value of the first physical quantity in response to input of the blend information, and
the second regression model is a function to output the second predictive value of the second physical quantity in response to input of the blend information.

11. A prediction result visualizing method of causing a computer to visualize a prediction result of a physical quantity of a composite material containing two or more materials belonging to a plurality of different materials as constituent materials, comprising steps of:
a first predictive value input step of causing the computer to input a first predictive value of a first physical quantity of an unknown composite material calculated on basis of a first regression model and blend information including a material name and a blend rate of a constituent material contained in the unknown composite material having an unknown value of the first physical quantity and an unknown value of a second physical quantity;
a second predictive value input step of causing the computer to input a second predictive value of the second physical quantity of the unknown composite material calculated on basis of a second regression model and the blend information including the material name and the blend rate of the constituent material contained in the unknown composite material;
a prediction result acquisition step of causing the computer to acquire a prediction result which is based on a plurality of first predictive values calculated while changing the blend rate and input by the first predictive value input step and a plurality of second predictive values calculated while changing the blend rate and input by the second predictive value input step and which is corresponded to the changed blend rate; and
a visualization step of causing the computer to visualize the prediction result,
wherein the first regression model is a function to output the first predictive value of the first physical quantity in response to input of the blend information, and
the second regression model is a function to output the second predictive value of the second physical quantity in response to input of the blend information.
